(19) United States
(12) Patent Application Publication
(10) Pub. No.: US 2012/0320318 A1
(43) Pub. Date: Dec. 20, 2012

(54) METHOD OF MANUFACTURING POLARIZING PLATE, POLARIZING PLATE MANUFACTURED USING THE METHOD, AND LIQUID CRYSTAL DISPLAY DEVICE

(75) Inventors: Hideyuki Sato, Hyogo (JP); Takahiro Takagi, Kanagawa (JP); Yasuhiro Watanabe, Tokyo (JP)

(73) Assignee: KONICA MINOLTA ADVANCED LAYERS, INC., Tokyo (JP)

(21) Appl. No.: 13/580,990

(22) PCT Filed: Feb. 15, 2011
(86) PCT No.: PCT/JP2011/053086

§ 371 Date: Aug. 24, 2012

(30) Foreign Application Priority Data
Mar. 3, 2010 (JP) 2010-046259

(51) Int. Cl. G02F 1/1335; B32B 37/14; G02B 5/30

(52) U.S. Cl. 349/96; 359/483.01; 156/60

(57) ABSTRACT

Disclosed is a method of manufacturing a polarizing plate safe in operation, less burdensome on the environment, and with excellent adhesion to a polarizer, also disclosed are a polarizing plate manufactured using said method, and a liquid crystal display device using said polarizing plate. In the method of manufacturing a polarizing plate, a polarizing plate is manufactured in which a protective film which is hydrophilized by alkali saponification is laminated to at least one surface of the polarizer. In the method, said protective film contains cellulose acetate, and the surface free energy before alkali saponification of said protective film satisfies formula (S_{I}), below, and the surface free energy after alkali saponification satisfies formula (S_{II}), below. Formula (S_{I}): 0.25≦γsh/γsp≦0.40; Formula (S_{II}): 1.5≦γsh/γsp≦3.0 (wherein γsh represents the hydrogen bond component of the surface free energy, and γsp represents the dipole component).

### TECHNICAL FIELD

The present invention relates to a polarizing plate and a liquid crystal display device using the same, and more specifically, to a polarizing plate obtainable via a manufacturing method in which excellent adhesion performance to a polarizer is expressed and excellent working safety and less environmental load are achieved; and a liquid crystal display device using the polarizing plate.

### BACKGROUND

As polarizing plate protective films, polymer films such as cellulose ester, polyethylene terephthalate (PET), cycloolefin polymer (COP), polycarbonate (PC) are known. Many methods of laminating these to polarizers represented by polyvinyl alcohol (PVA) are known.

As a polarizing plate protective film, a cellulose ester film is more widely used than other thermoplastic films because of its appropriate moisture permeability enabling adhesion to a PVA polarizer and drying to advance smoothly.

However, since a cellulose ester itself exhibits hydrophobicity, prior to the step of adhering to PVA, hydrophilization treatment is necessitated via alkali saponification, corona treatment, or plasma treatment.

Of these hydrophilization treatments, alkali saponification is the most widely used method. However, since an alkali aqueous solution of high temperature and high concentration is used, poor workability and poor environmental suitability are expressed. Especially, when diacetyl cellulose having been heretofore applied to an optical film for a λ/4 plate is subjected to alkali saponification, part of the film is eluted into the alkali saponification liquid, which has produced the problem that resulting precipitates cause process contamination.

An alkali saponification method in which additives in a film are prevented from being eluted into an alkali saponification liquid is proposed (refer to, for example, Patent Document 1).

However, in this method, a cellulose ester film having a large degree of acetyl group substitution such as triacetyl cellulose can be saponified with inhibition of the elution, but in a film employing a cellulose ester having a low degree of acetyl group substitution such as diacetyl cellulose, elution of the resin itself into the saponification liquid advances. Thereby, it was found out that even when the above technique was applied, use as a polarizing plate protective film was difficult.

Further, there is disclosed a technique in which an optical film employing a cellulose ester having a degree of acetyl group substitution of 2.0 to 3.0 is saponified using an alkali saponification liquid of 30° C. having a concentration of 1.5 mol/l (refer to, for example, Patent Document 2). However, the optical film was found to be problematic in adhesion performance to a polarizer.

### PRIOR ART DOCUMENTS

### Patent Documents

Patent Document 1: Unexamined Japanese Patent Application Publication No. 2006-335800

Patent Document 2: Unexamined Japanese Patent Application Publication No. 2010-2749

### BRIEF DESCRIPTION OF THE INVENTION

### Problems to be Solved by the Invention

In view of the above problems and circumstances, the present invention was completed, and an object thereof is to provide a method of manufacturing a polarizing plate in which excellent adhesion performance to a polarizer is expressed and excellent working safety and less environmental load are achieved; a polarizing plate manufactured using the above method; and a liquid crystal display device using the polarizing plate.

### Means to Solve the Problems

The above object of the present invention is achieved by the following constitution.

1. In a method of manufacturing a polarizing plate in which a protective film having been hydrophilized by alkali saponification is laminated to at least one face of a polarizer, a method of manufacturing the polarizing plate in which the protective film contains cellulose acetate; a surface free energy of the protective film prior to alkali saponification satisfies following Formula (S I); and a surface free energy of the protective film after alkali saponification satisfies following Formula (S II):

0.25≦γsh/γsp≦0.40 Formula (S I):

1.5≦γsh/γsp≦3.0 Formula (S II):

wherein γsh represents the hydrogen bond component of the surface free energy and γsp represents the dipolar component.

2. The method of manufacturing the polarizing plate described in item 1, in which the cellulose acetate is diacetyl cellulose having a degree of acetyl group substitution of 2.0 to less than 2.5.

3. The method of manufacturing the polarizing plate described in item 2, in which the cellulose acetate is diacetyl cellulose having a weight average molecular weight of 100,000 to less than 200,000.

4. The method of manufacturing the polarizing plate described in any of items 1-3, in which the protective film contains a hydrolysis inhibitor having a log P of at least 10.0 at 6.0% by mass or more based on the resin content.

5. The method of manufacturing the polarizing plate described in any of items 1-4, in which the mass change rate of the mass (b) after saponification and washing to the mass (a) prior to saponification of the protective film satisfies following Formula (W).

((b−a)/a)×100≧0(%) Formula (W):

a: Film mass after a protective film prior to alkali treatment has been subjected to 24-hour humidity conditioning under a condition of 23° C. and 55%

b: Film mass after a protective film has been subjected to 24-hour humidity conditioning under a condition of 23° C. and 55% after alkali treatment and washing

6. The method of manufacturing the polarizing plate described in any of items 1-5, in which a temperature of the alkali saponification is 25 to 50° C.

7. The method of manufacturing a polarizing plate described in any of items 1-5, in which an alkali (NaOH or KOH) concentration (mol/l) of the alkali saponification is 0.5 to less than 1.5

8. A polarizing plate manufactured by the method of manufacturing a polarizing plate described in any of items 1 to 7.

9.A liquid crystal display device incorporating a liquid crystal cell and two polarizing plates arranged on both sides thereof, in which at least one of the polarizing plates is the polarizing plate described in item 8.

### Effects of the Invention

The above means of the present invention makes it possible to provide a polarizing plate able to be manufactured by a manufacturing method in which excellent adhesion performance to a polarizer is expressed and excellent working safety and less environmental load are achieved, and further to provide a liquid crystal display device using the polarizing plate.

### PREFERRED EMBODIMENT OF THE INVENTION

An embodiment to carry out the present invention will now be detailed that by no means limits the scope of the present invention.

The method of manufacturing a polarizing plate of the present invention has a technical feature, in which in the method of manufacturing a polarizing plate where a protective film having been hydrophilized by alkali saponification is laminated to at least one face of a polarizer, the protective film contains cellulose acetate; the surface free energy of the protective film prior to alkali saponification satisfies following Formula (S I); and the surface free energy after alkali saponification satisfies following Formula (S II):

0.25≦γsh/γsp≦0.40 Formula (S I):

1.5≦γsh/γsp≦3.0 Formula (S II):

wherein γsh represents the hydrogen bond component of the surface free energy and γsp represents the dipolar component.

The present inventors found out the following in the course of diligent investigations on polarizing plates obtained by a manufacturing method in which excellent adhesion performance to a polarizer was expressed and excellent working safety and less environmental load were achieved: when a protective film laminated to at least one side of a polarizer contained cellulose acetate; the surface free energy of the protective film prior to alkali saponification satisfies above Formula (S I); and the surface free energy after alkali saponification satisfies above Formula (S II), excellent adhesion performance to a polarizer was expressed and pail of the film, especially, a resin constituting the film can be prevented from being eluted into an alkali saponification liquid, resulting in overcoming the problem that eluted substances contaminated the process.

Conventionally, to maintain the adhesion performance between a polarizer and a protective film under durability conditions such as high temperature and high humidity, it was necessary that the alkali concentration or the temperature of a saponification liquid was increased and saponification duration was extended. However, in the present invention, it was found out that when the surface free energy of a protective film prior to alkali saponification was adjusted to fall within the range of above Formula (S I), even under weak alkali saponification conditions such as low concentration and low temperature, saponification was adequately carried out.

At the same time, it was found out that as cellulose acetate achieving such a surface free energy prior to saponification, diacetyl cellulose having a degree of acetyl group substitution of 2.0 to less than 2.5 was preferably used.

Further, γsh/γsp represents the magnitude of the ratio of the hydrogen bond component in the surface free energy and generally increases with advance of hydrophilization treatment. When the above ratio is allowed to fall within the Hinge satisfying Formula (S II), excellent adhesion performance to PVA serving as the polarizer is expressed.

Accordingly, in the preferred embodiment of the present invention, from the viewpoint of producing the effects of the present invention, it is preferable that the above cellulose acetate be diacetyl cellulose having a degree of acetyl group substitution of 2.0 to less than 2.5; the above cellulose acetate be diacetyl cellulose having a weight average molecular weight of 100,000 to less than 200,000; and a hydrolysis inhibitor having a log P of at least 10.0 be contained at 6.0% by mass or more based on the resin content.

Further, the change rate of the mass (b) after saponification and washing to the mass (a) prior to saponification of the protective film preferably satisfies above Formula (W).

The liquid crystal display device of the present invention is constructed of a liquid crystal cell and 2 polarizing plates arranged on both sides thereof and at least one of the polarizing plates is preferably a polarizing plate manufactured by the method of manufacturing a polarizing plate.

The present invention, its constitutional elements, and embodiments and aspects to carry out the present invention will now be detailed.

### Surface Free Energy of a Protective Film

At least one protective film constituting the polarizing plate of the present invention is a protective film hydrophilized by alkali saponification, having the following technical feature: the surface free energy of the protective film prior to alkali saponification satisfies following Formula (S I) and the surface free energy after alkali saponification satisfies following Formula (S II):

0.25≦γsh/γsp≦0.40 Formula (S I):

1.5≦γsh/γsp≦3.0 Formula (S II):

wherein γsh represents the hydrogen bond component of the surface free energy and γsp represents the dipolar component.

When the value of Formula (S I) is less than 0.25, inadequate adhesion performance between a polarizer and a protective film is expressed under weak saponification conditions such as low concentration and low temperature.

When the value of Formula (S I) exceeds 0.40, a resin is excessively eluted into a saponification liquid, which is basically inapplicable to alkali saponification.

The method of changing the ratio (γsh/γsp) of the hydrogen bond component to the dipolar component of the surface free energy includes changing the degree of substitution of cellulose acetate, changing the structures and added amounts of additives, and adjusting hydrophilization treatment conditions.

The ratio (γsh/γsp) of the hydrogen bond component to the dipolar component of the surface free energy after hydrophilization treatment represented by Formula (S II) is commonly 1.5 to 3.0, preferably 1.8 to 3.0, more preferably 2.0 to 3.0.

When the surface free energy (γsh/γsp) after hydrophilization treatment is less than 1.5, inadequate adhesion performance to a hydrophilic polarizer is expressed and then the effects of the present invention are practically insufficiently produced.

When the surface free energy (γsh/γsp) after hydrophilization treatment exceeds the upper limit of Formula (S II), in the case of use of cellulose acetate having a degree of acetyl group substitution of less than 2.5, the elution of the resin itself into a saponification liquid (i.e., hydrolysis of the main chain of the resin) advances, resulting in contamination of the saponification liquid and dot defects in the polarizing plate.

### Determination of Surface Free Energy

In the present invention, the surface free energy of a protective film was determined as described below.

For determination, a protective film prior to alkali saponification was subjected to humidity conditioning under a condition of 23° C. and 55% for 24 hours. A protective film after alkali saponification was alkali-treated and washed, followed by 24-hour humidity conditioning under a condition of 23° C. and 55% to be measured.

The contact angle between each of three types of reference liquid of pure water, nitromethane, and methylene iodide and the above determined solid (in the present invention, a protective film) was measured 5 times using contact angle meter CA-V (produced by Kyowa Interlace Science Co., Ltd.) to obtain an average contact angle from the average value of measured values. Then, on the basis of Young-Dupre Equation and extended Fowkes Equation, 3 components of the surface free energy of the solid were calculated.

W_{SL}=γL(1+cos θ) Young-Dupre Equation:

W_{SL}: Adhesion energy between liquid and solid

γL: Surface free energy of the liquid

θ: Contact angle between the liquid and the solid

W_{SL}=2{(γsdγLd)^{1/2}+(γspγLp)^{1/2}+(γshγLh)^{1/2}} Extended Fowkes Equation:

γL=γLd+γLp+γLh: Surface free energy of liquid

γs=γsd+γsp+γsh: Surface free energy of solid

γd, γp, and γh: Each component of dispersion, dipole, and hydrogen bond of the surface free energy

Each component value (mN/m) of the surface free energy of a reference liquid is known as shown in following Table 1. Therefore, when the simultaneous equation with three unknowns is solved using a contact angel value, each of the component values (γsd, γsp, and γsh) of the surface free energy of the solid surface can be determined.

TABLE 1

| Reference Liquid | γLp | γLd | γLh |
|---|---|---|---|
| water | 0.0 | 30.4 | 42.4 |
| nitromethane | 17.7 | 18.3 | 0.0 |
| diiodomethane | 0.0 | 51.0 | 0.0 |

unit: mN/m

### Cellulose Acetate

The protective film according to the present invention is required to be a film containing cellulose acetate in order that the surface free energy of the film after hydrophilization satisfies Formulas (S I) and (S II) and the object of the present invention is achieved.

The cellulose acetate is preferably diacetyl cellulose having a degree of acetyl group substitution of 2.0 to less than 2.5. The degree of acetyl group substitution can be determined based on ASTM D817-96.

In the case of a film containing cellulose acetate having a degree of acetyl group substitution of more than 2.5, Formula (S I) cannot be satisfied at all. And, to satisfy Formula (S II), stronger alkali saponification conditions need to be employed. In the case of such stronger alkali saponification conditions, elution into a saponification liquid is liable to occur depending on the type of additive to be used, which is also unfavorable in view of safety and the environment.

In the case of a degree of acetyl group substitution of less than 2.0, the hydrophilicity of the resin is excessively large and thereby moisture permeability increases, resulting in an unsatisfied polarizing plate protection function. Further, in the case of use as an optical compensation film, retardation varies to a large extent with respect to temperature and humidity, and in the case of use as a liquid crystal display device, viewing angle and color tone vary to a large extent, which is unfavorable.

Further, the cellulose acetate is preferably diacetyl cellulose having a weight average molecular weight of 100,000 to less than 200,000, more preferably 150,000 to less than 200,000, from the viewpoint of preventing the resin from being eluted into an alkali saponification liquid.

When only a small-molecular weight resin of a weight average molecular weight of less than 100,000 is used, saponification liquid durability is relatively small and therefore a large-molecular weight resin as described above is preferable.

The weight average molecular weight Mw of cellulose acetate is determined using gel permeation chromatography (GPC).

Measurement conditions are as follows:

Solvent: Methylene chloride

Column: Shodex K806, K805, and K803G (produced by Showa Denko K.K., these three columns were connected together and used)

Column temperature: 25° C.

Sample concentration: 0.1% by mass

Detector: RI Model 504 (produced by GL Sciences Inc.)

Pump: L6000 (produced by Hitachi, Ltd.)

Flow rate: 1.0 ml/min

Calibration curve: A calibration curve prepared based on 13 samples of standard polystyrene STK Standard Polystyrene (produced by Tosoh Corp.) ranging from 500 to 1000,000 in terms of Mw was employed. The 13 samples are used at nearly equal intervals.

Cellulose as the raw material of the cellulose acetate according to the present invention is not specifically limited, including cotton linter, wood pulp, and kenaf.

The cellulose acetate according to the present invention can be produced by a well-known method and synthesized specifically with reference to the method described in Unexamined Japanese Patent Application Publication No. H10-45804.

As commercially available products, there are listed acetyl celluloses such as LM80, L20, L30, L40, and L50 (produced by Dated Chemical Industries, Ltd.) and Ca398-3, Ca398-6, Ca398-10, Ca398-30, and Ca398-60S (produced by Eastman Chemical Co.).

### Additives for Protective Film

In the protective film of the present invention (hereinafter, the protective film of the present invention may be referred to as the cellulose acetate film), additives (hydrolysis inhibitors, retardation adjusters, plasticizers, UV absorbents, antioxidants, acid scavengers, and fine particles) based on the intended use can be added, as long as the surface free energy of the film after hydrophilization treatment satisfies above Formulas (S I) and (S II). Of these, a hydrolysis inhibitor having a log P of at least 10.0 is preferably incorporated in the protective film of the present invention at 6.0% by mass or more based on the resin content in order to adjust Formulas (S I) and (S II) to fall within the range of the present invention.

### Hydrolysis Inhibitors

As a hydrolysis inhibitor having a log P of at least 10.0, there can be preferably used a mixture of ester compounds having, for example, 1 to 12 of at least one kind of pyranose structure and furanose structure in which the OH groups of the structure are partially esterified.

The esterification rate of an ester compound having 1 to 12 of at least one kind of pyranose structure and furanose structure in which the OH groups of the structure are thoroughly or partially esterified is preferably at least 70% based on the OH groups present in the pyranose structure or furanose structure.

Hereinafter, the above ester compound is referred to also as a sugar ester compound collectively.

As examples of the ester compound, for example, the following can be cited.

There are listed glucose, galactose, mannose, fructose, xylose, arabinose, lactose, sucrose, nystose, 1F-fructosylnystose, stachyose, maltitol, lactitol, lactulose, cellobiose, maltose, cellobiose, maltotriose, raffinose, and kestose.

In addition, gentiobiose, gentiotriose, gentiotetraose, xylotriose, and galactosyl-sucrose are cited.

Of these compounds, a compound having both a pyranose structure and a fructose structure is preferable.

For example, sucrose, kestose, nystose, 1F-fructosylnystose, and stachyose are preferable, and sucrose is more preferable.

An ester compound of oligosaccharide is applicable as a compound having 1 to 12 of at least one kind of pyranose structure and furanose structure.

Further, the ester compound is a compound in which 1 to 12 of at least one kind of pyranose structure and furanose structure represented by following Formula (A) are condensed. Herein, R₁₁ to R₁₅ and R₂₁ to R₂₅ represent an acyl group having a carbon number of 2 to 22 or a hydrogen atom; m and n each represent an integer of 0 to 12; and m+n represents an integer of 1 to 12.

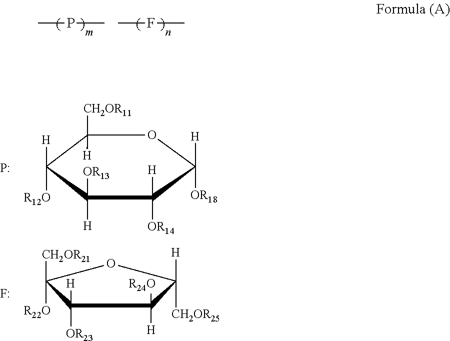

R₁₁ to R₁₅ and R₂₁ to R₂₅ each are preferably a benzoyl group or a hydrogen atom. The benzoyl group may further have a substituent R₂₆, including, for example, an alkyl group, an alkenyl group, an alkoxyl group, and a phenyl group. These alkyl, alkenyl, and phenyl groups may further have a substituent.

Specific examples of the ester compound are listed below.

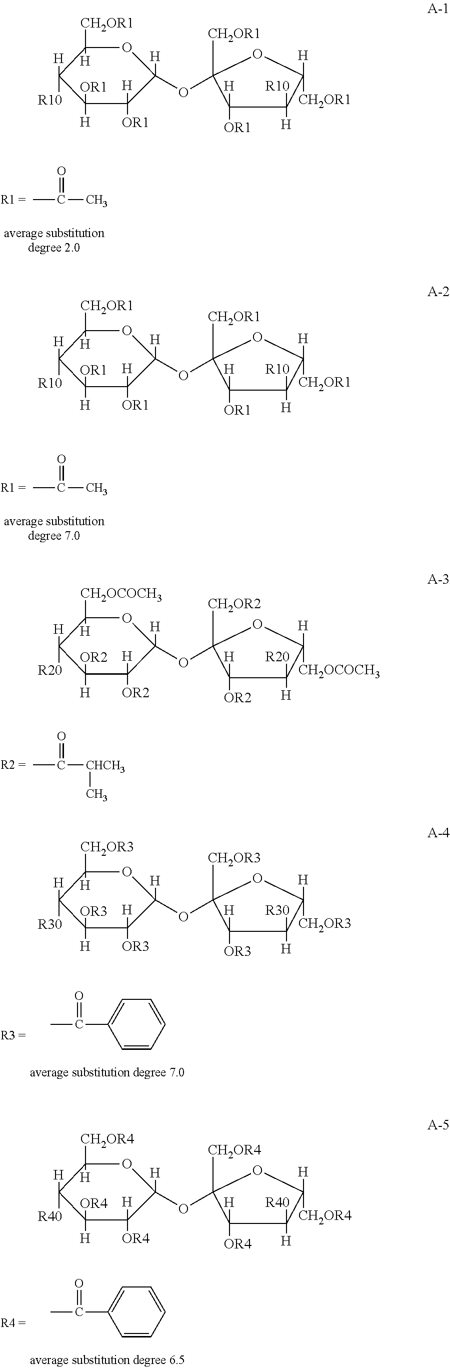

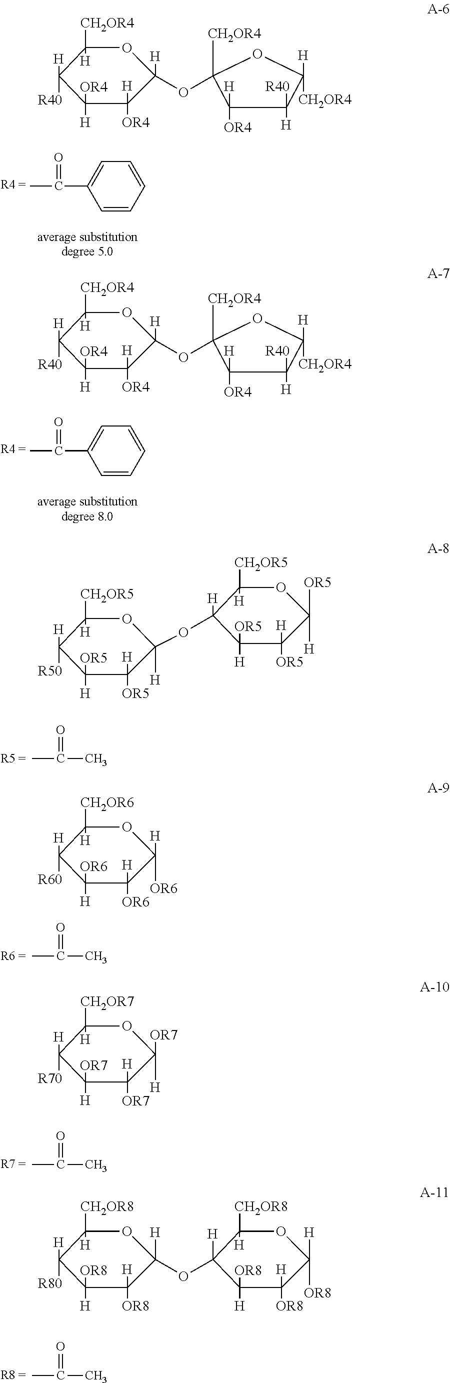

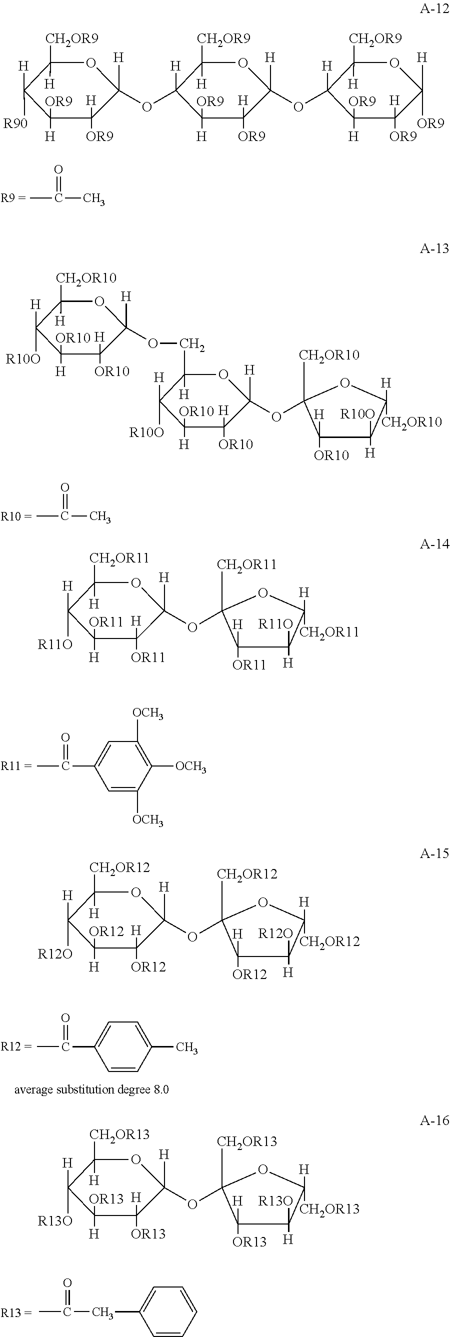

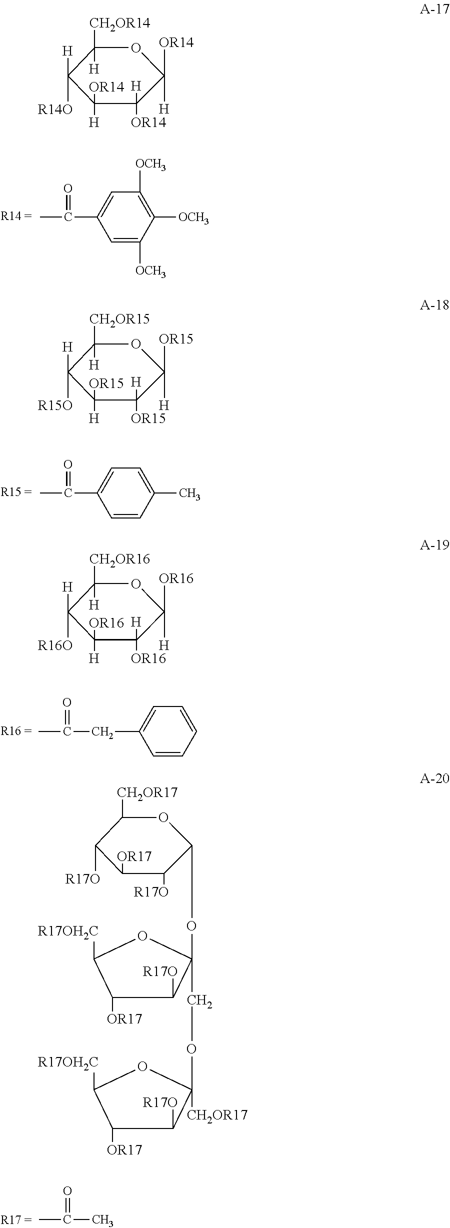

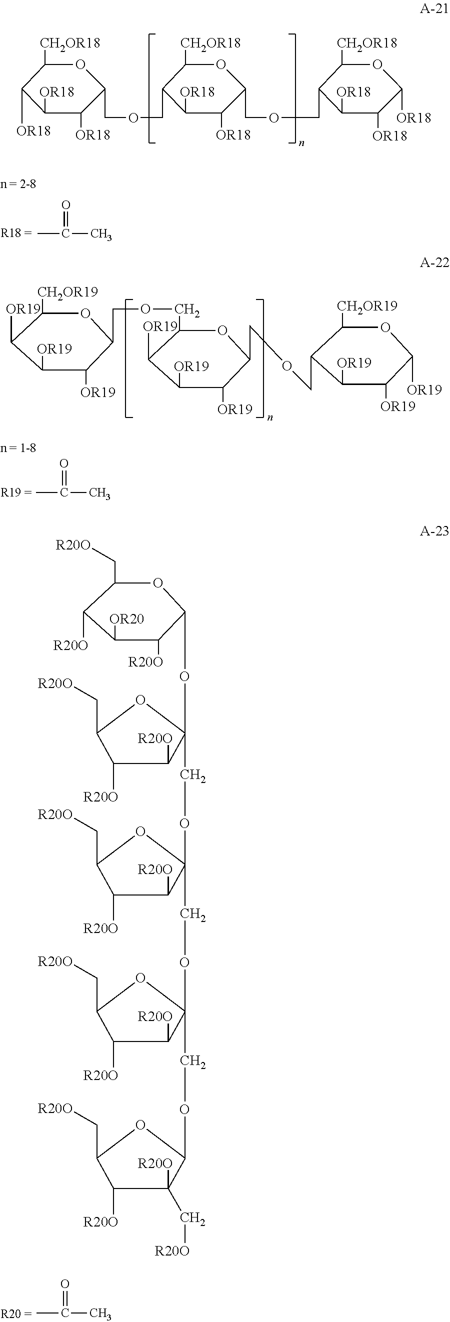

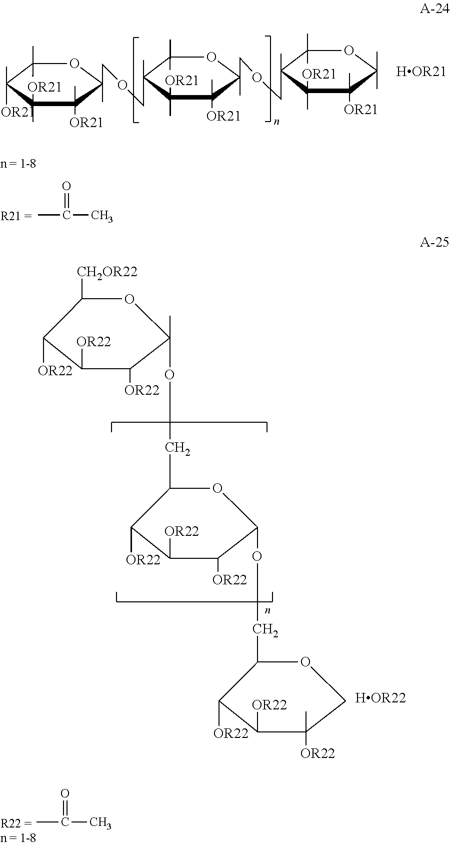

The cellulose acetate film according to the present invention preferably contains a hydrolysis inhibitor at 6.0% by mass or more based on cellulose acetate, specifically preferably 6.0 to 15% by mass.

### Retardation Adjusted

As the retardation adjuster, for example, an ester compound represented by following Formula (1) can be preferably used.

B-(G-A)n-G-B Formula (1):

wherein B represents a hydroxy group or a carboxylic acid residue; G represents an alkylene glycol residue having a carbon number of 2 to 12, an aryl glycol residue having a carbon number of 6 to 12, or an oxyalkylene glycol residue having a carbon number of 4 to 12; A represents an alkylene dicarboxylic acid residue having a carbon number of 4 to 12 or an aryl dicarboxylic acid residue of a carbon number of 6 to 12; and n represents an integer of at least 1.

In Formula (1), a structure is made of a hydroxy group or a carboxylic acid residue represented by B; an alkylene glycol residue, an oxyalkylene glycol residue, or an aryl glycol residue represented by G; and an alkylene dicarboxylic acid residue or an aryl dicarboxylic acid residue represented by A, being obtained via the same reaction as for a commonly used ester compound.

The carboxylic acid component of the ester compound represented by Formula (1) includes, for example, acetic acid, propionic acid, butyric acid, benzoic acid, para-tertiary-butyl benzoic acid, ortho-toluic acid, meta-toluic acid, para-toluic acid, dimethyl benzoic acid, ethyl benzoic acid, n-propyl benzoic acid, aminobenzoic acid, acetoxy benzoic acid, and aliphatic acids. These may be used alone or in combination of at least two types thereof.

The alkylene glycol component having a carbon number of 2 to 12 of the ester compound represented by Formula (1) includes ethylene glycol, 1-propylene glycol, 1,3-propylene glycol, 1,2-butanediol, 1,3-butanediol, 1,2-propanediol, 2-methyl-1,3-propanediol, 1,4-butanediol, 1,5-pentanediol, 2,2-dimethyl-1,3-propanediol (also known as neopentyl glycol), 2,2-diethyl-1,3-propanediol (also known as 3,3-dimethylol pentane), 2-n-butyl-2-ethyl-1,3-propanediol (also known as 3,3-dimethylol heptane), 3-methyl-1,5-pentanediol-1,6-hexanediol, 2,2,4-trimethyl-1,3-pentanediol, 2-ethyl-1,3-hexanediol, 2-methyl-1,8-octanediol, 1,9-nonanediol, 1,10-decanediol, and 1,12-octadecanediol. These glycols may be used alone or in combination of at least two types thereof.

An alkylene glycol having a carbon number of 2 to 12 is specifically preferable because of excellent compatibility with cellulose acetate.

Further, the oxyalkylene glycol component having a carbon number of 4 to 12 of the ester compound represented by Formula (1) includes, for example, diethylene glycol, triethylene glycol, tetraethylene glycol, dipropylene glycol, and tripropylene glycol. These glycols may be used alone or in combination of at least two types thereof.

The alkylene dicarboxylic acid component having a carbon number of 4 to 12 of the ester compound represented by Formula (1) includes, for example, succinic acid, maleic acid, fumaric acid, glutaric acid, adipic acid, azelaic acid, sebacic acid, and dodecane dicarboxylic acid. These may be used alone or in combination of at least two types thereof. The arylene dicarboxylic acid component having a carbon number of 6 to 12 includes phthalic acid, terephthalic acid, isophthalic acid, 2,6-naphthalene dicarboxylic acid, and 1,4-naphthalene dicarboxylic acid.

The number average molecular weight of the ester compound represented by Formula (1) is preferably 300 to 1,500, more preferably 400 to 1,000, Further, the acid value and the hydroxyl value thereof are preferably at most 0.5 mg KOH/g and at most 25 mg KOH/g, more preferably at most 0.3 mg KOH/g and at most 15 mg KOH/g, respectively.

Specific compounds of the ester compound represented by Formula (1) are shown below.

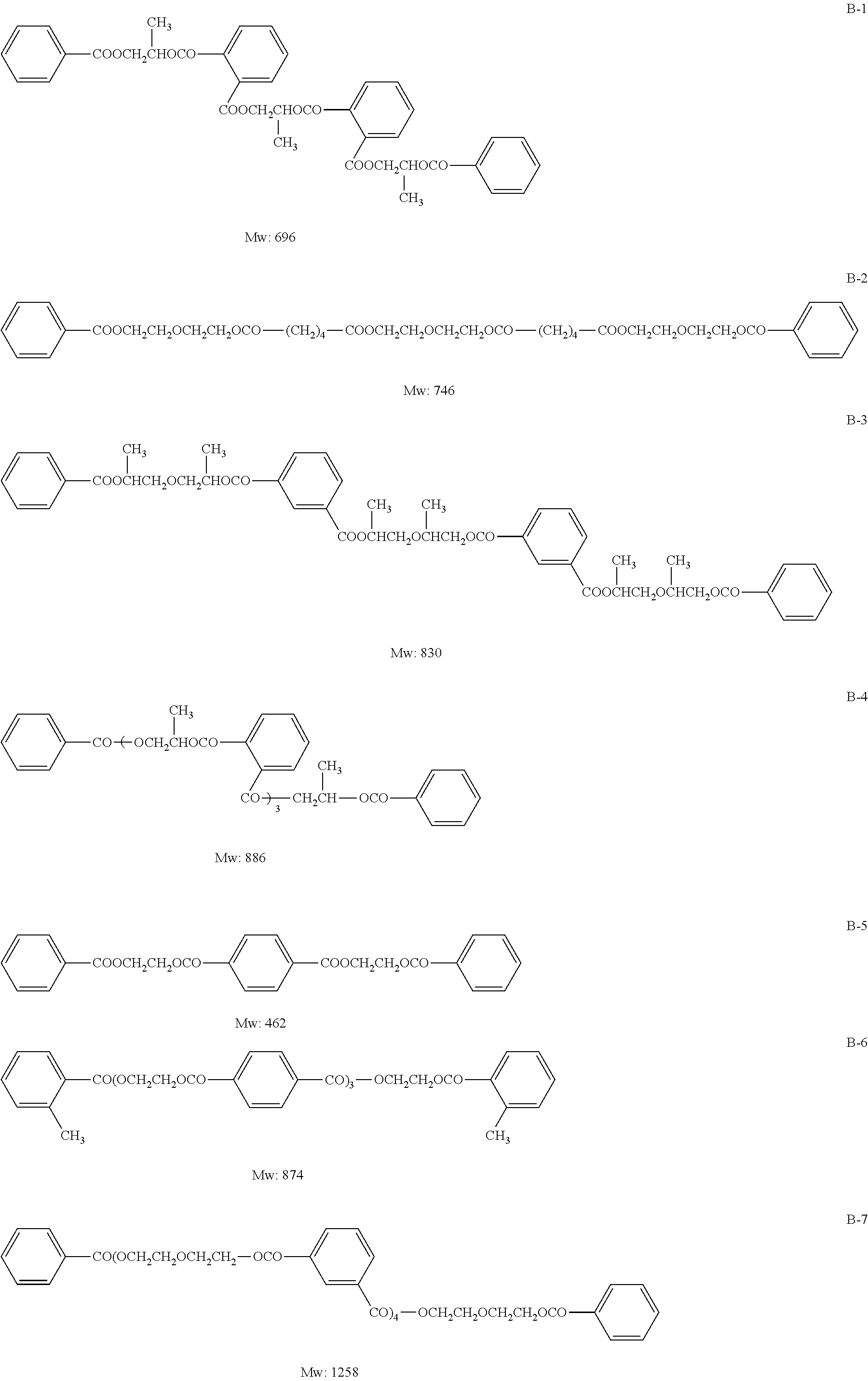

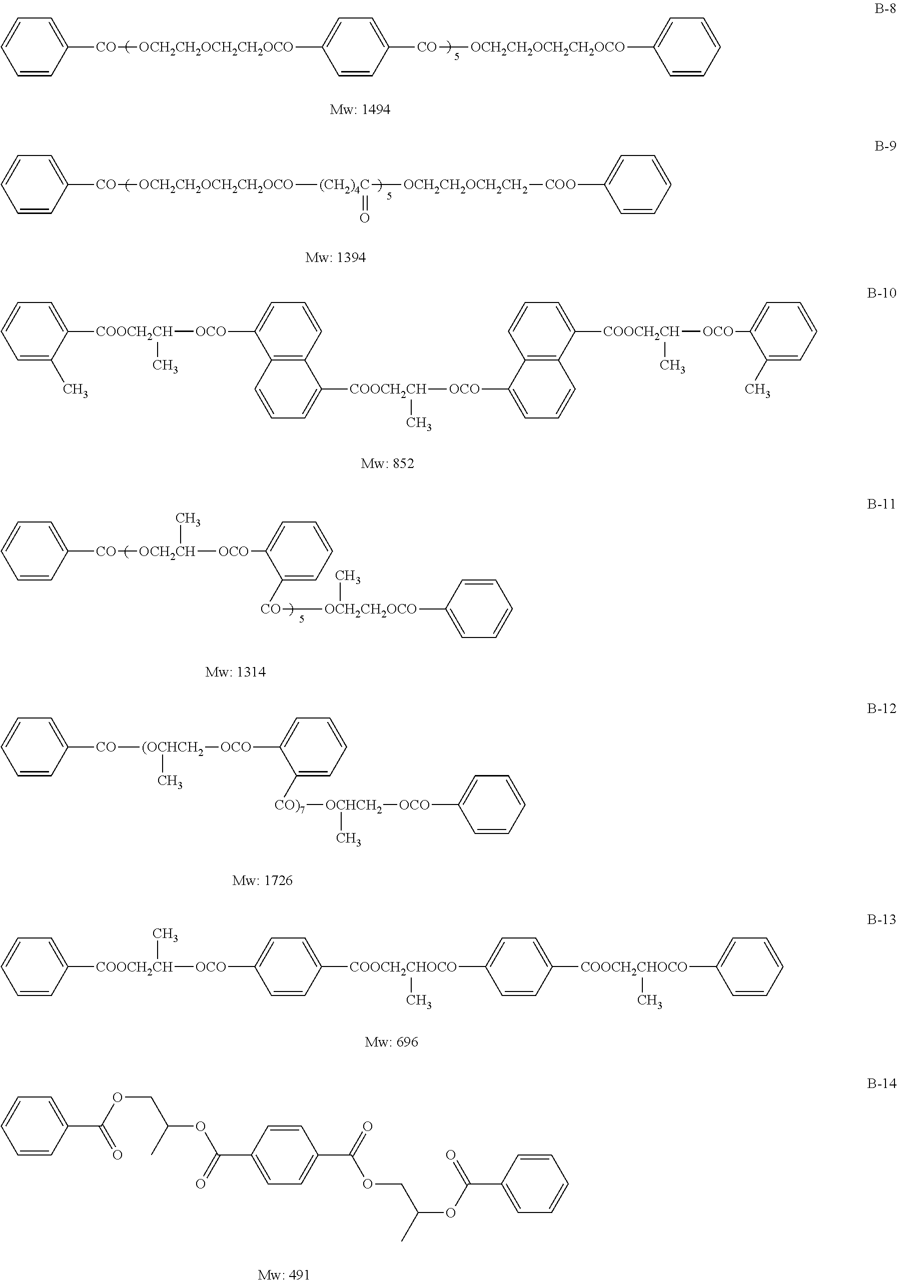

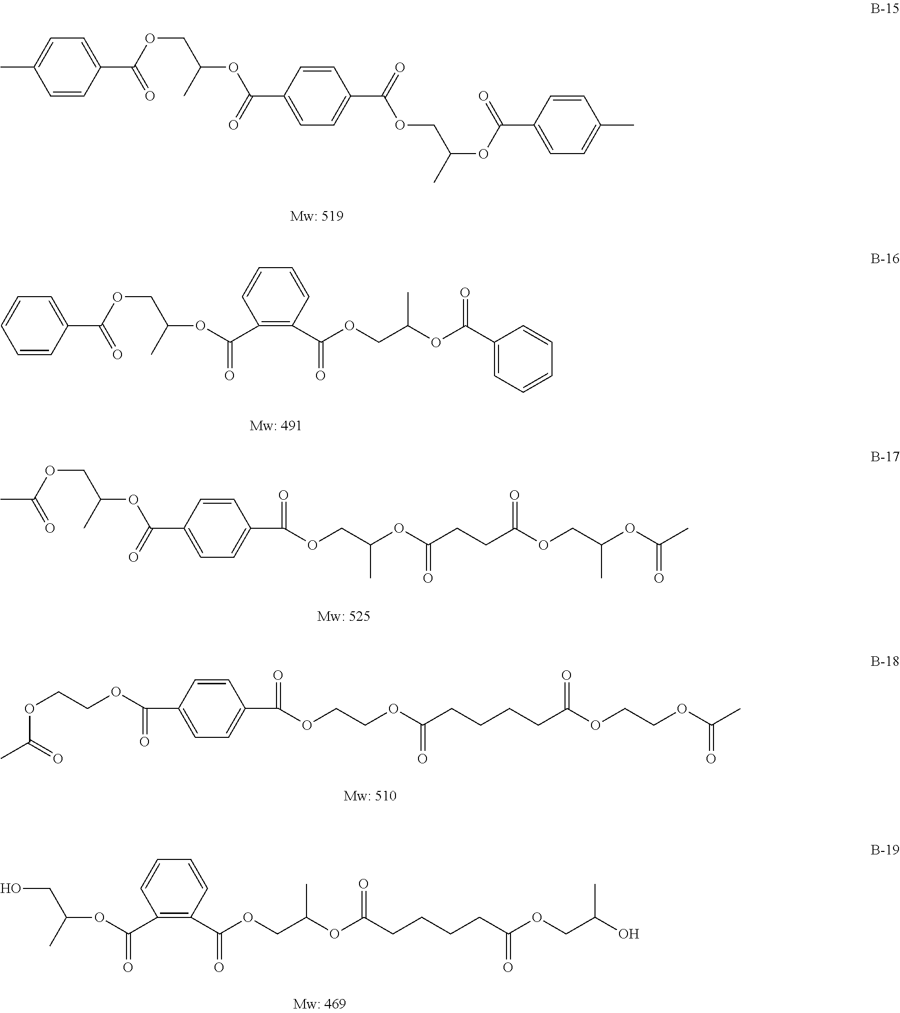

The cellulose acetate film according to the present invention preferably contains a retardation adjuster at 0.1 to 30% by mass based on the cellulose acetate film, specifically preferably 0.5 to 10% by mass.

### Plasticizers

The cellulose acetate film according to the present invention can contain a plasticizer as appropriate.

The plasticizer is not specifically limited, being, however, selected from a polycarboxylic acid ester plasticizer, a glycolate plasticizer, a phthalic acid ester plasticizer, a fatty acid ester plasticizer, a polyol ester plasticizer, a polyester plasticizer, and an acrylate plasticizer.

Of these, when at least two types of plasticizer are used, at least one type is preferably a polyol ester plasticizer.

The polyol ester plasticizer is a plasticizer composed of an ester of an aliphatic polyol having a valence of at least 2 and a monocarboxylic acid, preferably having an aromatic ring or a cycloalkyl ring in the molecule. An aliphatic polyol ester having a valence of 2 to 20 is preferable.

The polyol preferably used in the present invention is represented by following Formula (a):

R₁—(OH)n Formula (a):

wherein, R₁ represents an organic group having a valence of n; n represents a positive integer of at least 2; and the OH group represents at least one of an alcoholic and a phenolic hydroxyl group.

As preferable examples of the polyol, for example, the following can be listed.

Namely, there are listed adonitol, arabitol, ethylene glycol, diethylene glycol, triethylene glycol, tetraethylene glycol, 1,2-propanediol, 1,3-propanediol, dipropylene glycol, tripropylene glycol, 1,2-butanediol, 1,3-butanediol, 1,4-butanediol, dibutylene glycol, 1,2,4-butanetriol, 1,5-pentanedial, 1,6-hexanediol, hexanetriol, galactitol, mannitol, 3-methylpentane-1,3,5-triol, pinacol, sorbitol, trimethylolpropane, trimethylolethane and xylitol.

Of these, methylene glycol, tetraethylene glycol, dipropylene glycol, tripropylene glycol, sorbitol, trimethylol propane and xylitol are specifically preferable.

The monocarboxylic acid used for the polyol ester is not specifically limited, and a well-known aliphatic monocarboxylic acid, alicyclic monocarboxylic acid and aromatic monocarboxylic acid can be used. An aliphatic monocarboxylic acid and an aromatic monocarboxylic acid are preferably used to improve moisture permeability and retention properties.

Such a carboxylic acid used for the polyol ester may be used alone or in combination of at least two types.

Specific compounds of the polyol ester are exemplified below.

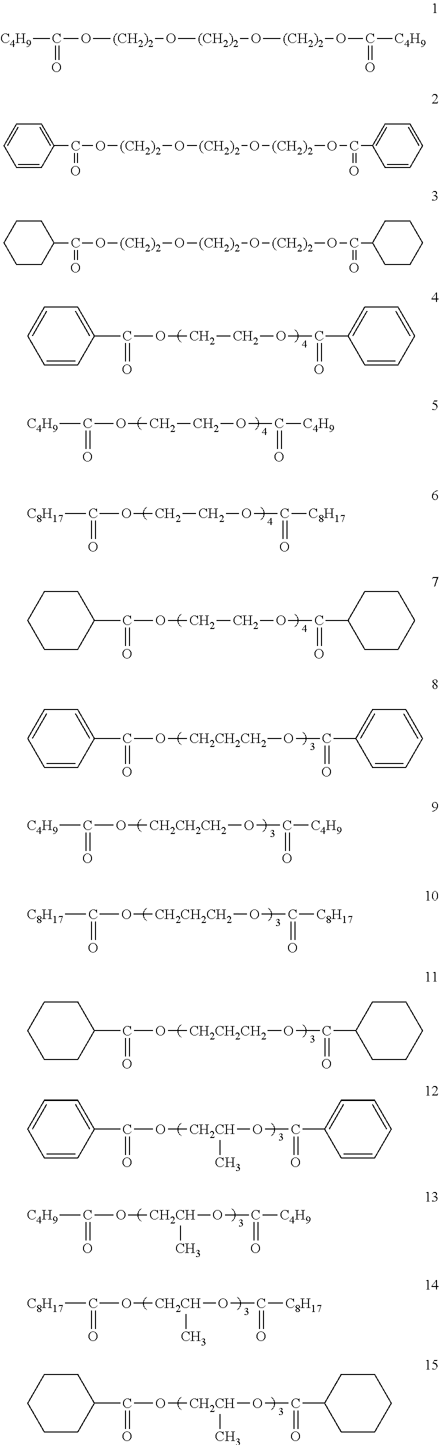

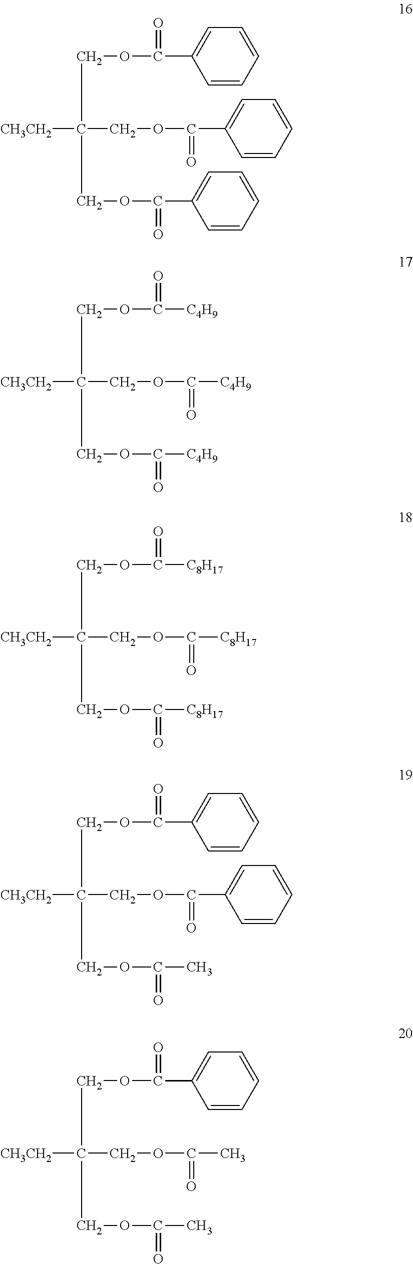

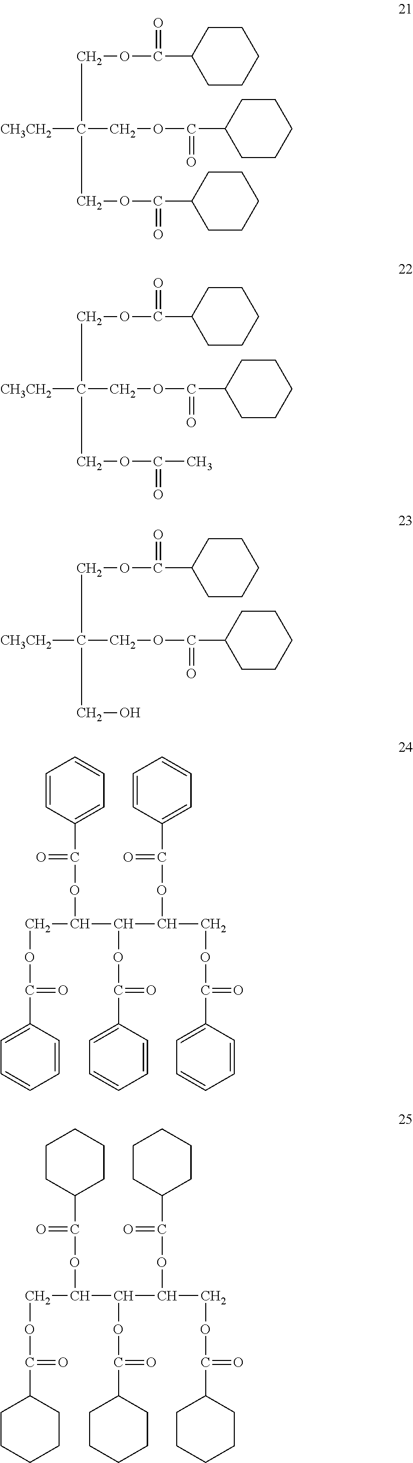

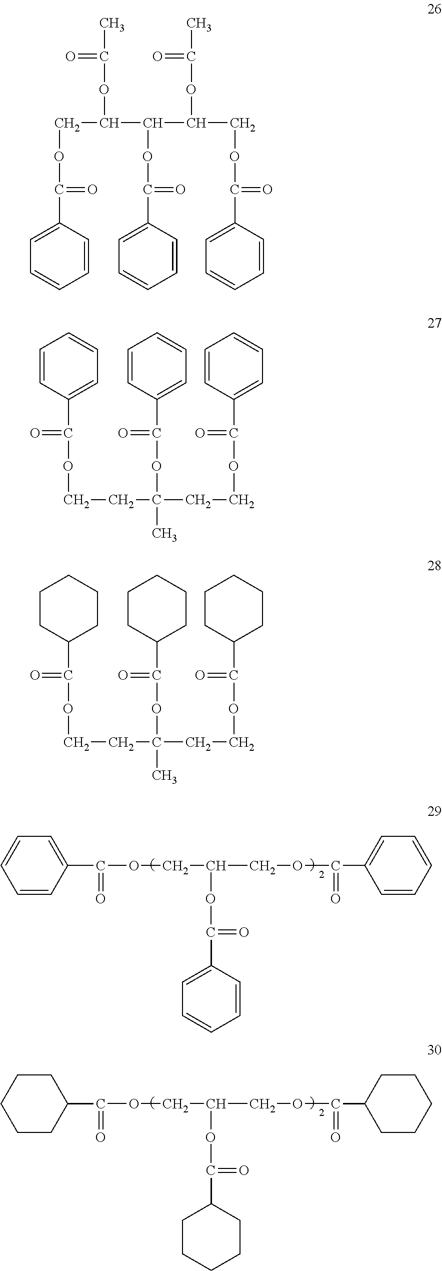

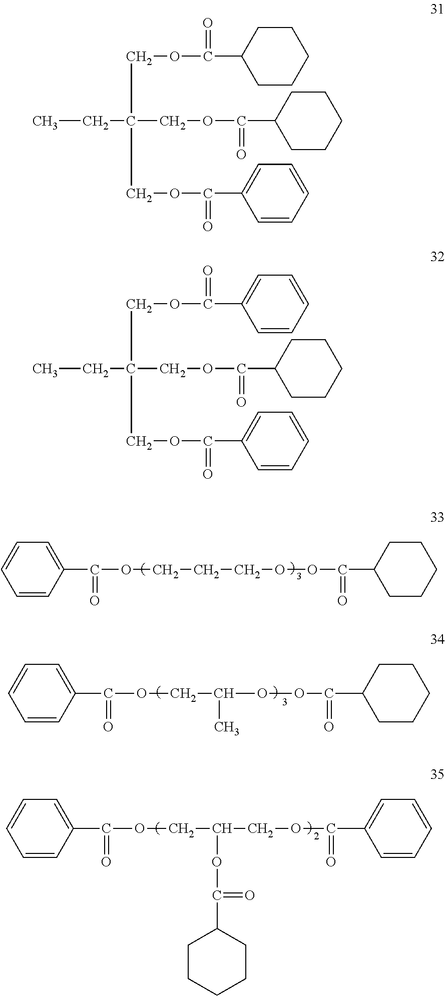

The glycolate plasticizer is not specifically limited but alkyl phthalyl alkyl glycolates can be preferably used.

The alkyl phthalyl alkyl glycolates include, for example, methyl phthalyl methyl glycolate, ethyl phthalyl ethyl glycolate, propyl phthalyl propyl glycolate, butyl phthalyl butyl glycolate, octyl phthalyl octyl glycolate, methyl phthalyl ethyl glycolate, ethyl phthalyl methyl glycolate, ethyl phthalyl propyl glycolate, methyl phthalyl butyl glycolate, ethyl phthalyl butyl glycolate, butyl phthalyl methyl glycolate, butyl phthalyl ethyl glycolate, propyl phthalyl butyl glycolate, butyl phthalyl propyl glycolate, methyl phthalyl octyl glycolate, ethyl phthalyl octyl glycolate, octyl phthalyl methyl glycolate and octyl phthalyl ethyl glycolate.

A phthalic acid ester plasticizer includes diethyl phthalate, dimethoxy ethyl phthalate, dimethyl phthalate, dioctyl phthalate, dibutyl phthalate, di-2-ethylhexyl phthalate, dioctyl phthalate, dicyclohexyl phthalate and dicyclohexyl terephthalate.

A citric acid ester plasticizer includes acetyl trimethyl citrate, acetyl triethyl citrate and acetyl tributyl citrate.

A fatty acid ester type plasticizer includes butyl oleate, methyl acetyl ricinoleate and dibutyl sebacate.

A phosphoric acid ester plasticizer includes triphenyl phosphate, tricresyl phosphate, cresyl diphenyl phosphate, octyl diphenyl phosphate, diphenyl biphenyl phosphate, trioctyl phosphate and tributyl phosphate.

The polycarboxylic acid ester plasticizer is composed of an ester of a polycarboxylic acid having a valence of at least 2, preferably 2 to 20, and alcohol. The valence of an aliphatic polycarboxylic acid is preferably 2 to 20, and the valences of an aromatic polycarboxylic acid and an alicyclic polycarboxylic acid each are preferably 3 to 20.

The polycarboxylic acid is represented by following Formula (b):

R₂(COOH)ₘ(OH)ₙ Formula (b):

wherein R₂ represents an organic group having a valence of (m+n); m represents a positive integer of at least 2; n represents an integer of at least 0; the COOH group represents a carboxyl group; and the OH group represents an alcoholic or phenolic hydroxyl group.

The molecular weight of the polycarboxylic acid ester compound is not specifically limited, being, however, preferably 300 to 1,000, more preferably 350 to 750. From the viewpoint of retention properties improvement, the molecular weight is preferably large, while being preferably small from the viewpoint of moisture permeability and the compatibility with cellulose acetate.

An alcohol used for the polycarboxylic acid ester may be used alone or in combination of at least two types.

The acid value of the polycarboxylic acid ester compound is preferably at most 1 mg KOH/g, more preferably at most 0.2 mg KOH/g. The acid value is preferably allowed to fall within the above range since retardation variation due to the ambience can be suppressed.

Incidentally, the acid value refers to the amount of potassium hydroxide in mg required to neutralize an acid contained in 1 g of a sample (namely, a carboxyl group present in the sample). The acid value was determined based on JIS K0070.

A specifically preferable polycarboxylic acid ester compound includes triethyl citrate, tributyl citrate, acetyltriethyl citrate (ATEC), acetyltributyl citrate (ATBC), benzoyltributyl citrate, acetyltriphenyl citrate, acetyltribenzyl citrate, dibutyltartrate, diacetyldibutyl tartrate, tributyl trimellitate and tetrabutyl pyromellitate.

### UV Absorbents

A UV absorbent absorbs UV radiation of at most 400 nm to enhance durability. The transmittance especially at a wavelength of 370 nm is preferably at most 10%, more preferably at most 5%, still more preferably at most 2%.

A UV absorbent used is not specifically limited, including, for example, an oxybenzophenone compound, a benzotriazole compound, a salicylic acid ester compound, a benzophenone compound, a cyanoacrylate compound, a triazine compound, a nickel complex salt compound and inorganic powder.

For example, there are listed 5-chloro-2-(3,5-di-sec-butyl-2-hydroxylphenyl)-2H-benzotriazole, (2-2H-benzotriazole-2-yl)-6-(straight chain and branched dodecyl)-4-methylphenol, 2-hydroxy-4-benzyloxybenzophenone and 2,4-benzyloxybenzophenone, as well as TINUVINs such as TINUVIN 109, TINUVIN 171, TINUVIN 234, TINUVIN 326, TINUVIN 327 and TINUVIN 328, which are available on the market from BASF Japan Ltd and preferably used.

A UV absorbent preferably used in the present invention includes a benzotriazole-based UV absorbent, a benzophenone-based UV absorbent, and a triazine-based UV absorbent. A benzotriazole-based UV absorbent and a benzophenone-based UV absorbent are specifically preferable.

In addition, a disc-shaped compound such as a compound having a 1,3,5-triazine ring is also preferably used as a UV absorbent.

The polarizing plate protective film of the present invention preferably contains at least two types of UV absorbent.

Further, a polymer UV absorbent can also be preferably used as a UV absorbent. Any of the polymer type UV absorbents described in Unexamined Japanese Patent Application Publication No. H06-148430 is specifically preferably used.

As the adding method of a UV absorbent, a UV absorbent may be dissolved in alcohol such as methanol, ethanol, or butanol; an organic solvent such as methylene chloride, methyl acetate, acetone, or dioxolan; or a mixed solvent thereof to be added into a dope; or may be directly added into a dope composition.

Those insoluble in an organic solvent such as inorganic powder are dispersed in an organic solvent and cellulose acetate using a dissolver or a sand mill to be added into a dope.

The used amount of a UV absorbent is not uniform, depending on the type of UV absorbent and use conditions thereof. However, in the case where the dry film thickness of a polarizing plate protective film is 30 to 200 μm, the amount is preferably 0.5 to 10% by mass, more preferably 0.6 to 4% by mass, based on the mass of the polarizing plate protective film.

When the above UV absorbent exhibits poor compatibility with other materials, inclusion into a functional layer may be carried out.

### Antioxidants

An antioxidant is also called an anti-degradation agent. When a liquid crystal display device is placed at high temperature/humidity, a cellulose acetate film may be degraded.

An antioxidant has a role in retarding and preventing decomposition of a cellulose acetate film due to, for example, halogens in the residual solvent in the cellulose acetate film or phosphoric acid in phosphoric acid-based plasticizers, being, therefore, preferably contained in the cellulose acetate film.

As such an antioxidant, a hindered phenol-based compound is preferably used, including, for example, 2,6-di-t-butyl-p-cresol, pentaerythrityl-tetrakis[3-(3,5-di-t-butyl-4-hydroxyphenyl)propionate], triethylene glycol-bis[3-(3-t-butyl-5-methyl-4-hydroxyphenyl)propionate], 1,6-hexanediol-bis[3-(3,5-di-t-butyl-4-hydroxyphenyl)propionate], 2,4-bis(n-octylthio)-6-(4-hydroxy-3,5-di-t-butylanilino)-1,3,5-triazine, 2,2-thio-diethylene-bis[3-(3,5-t-butyl-4-hydroxyphenyl)propionate],octadecyl-3-(3,5-di-t-butyl-4-hydroxyphenyl)propionate, N,N′-hexamethylene-bis(3,5-di-t-butyl-4-hydroxy-4-hydroxyhydrocinnamide), 1,3,5-trimethyl-2,4,6-tris(3,5-di-t-butyl-4-hydroxybenzyl)benzene and tris-(3,5-di-t-butyl-4-hydroxybenzyl)-isocyanurate.

Specifically preferable are 2,6-di-t-butyl-p-cresol, pentaerythrityl-tetrakis[3-(3,5-di-t-butyl-4-hydroxyphenyl)propionate] and triethylene glycol-bis[3-(3-t-butyl-5-methyl-4-hydroxyphenyl)propionate]. Further, for example, a hydrazine-based metal deactivator such as N,N′-bis[3-(3,5-di-t-butyl-4-hydroxyphenyl)propionyl]hydrazine or a phosphorous processing stabilizer such as tris(2,4-di-t-butylphenyl)phosphite may be used in combination.

The added amount of such a compound is preferably 1 ppm to 1.0% by mass, more preferably 10 ppm to 1,000 ppm by mass as the mass ratio with respect to the cellulose acetate.

### Acid Scavengers

Decomposition of cellulose acetate is accelerated even by an acid at high temperature, and therefore in the case of use for the protective film of the present invention, an acid scavenger is preferably contained therein.

As useful acid scavengers, any compounds able to inactivate an acid via reaction therewith can be used with no limitation. Of these, the compounds having an epoxy group described in U.S. Pat. No. 4,137,201 specification are preferable. Epoxy compounds as such acid scavengers are well known in the art, including diglycidyl ethers of polyglycols, especially, polyglycols derived by condensation of about 8 to 40 mol of ethylene oxides with respect to 1 mol of polyglycol, diglycidyl ethers of glycerols, metal epoxy compounds (for example, those which have been conventionally employed in vinyl chloride polymer compositions and together with vinyl chloride polymer compositions), epoxidized ether condensation products, diglycidyl ethers of bisphenol A (namely, 4,4′-dihydroxydiphenyldimethylmethane), epoxidized unsaturated fatty acid esters (especially, esters of alkyl groups having about 2 to 4 carbon atoms and fat acids having 2 to 22 carbon atoms (for example, butyl epoxystearate)), epoxidized vegetable oils which can be represented and exemplified by compositions of epoxidized long chain fatty acid triglycerides (for example, epoxidized soybean oil) and other unsaturated natural oils (these are occasionally referred to as epoxidized natural glycerides or unsaturated fatty acids and these fatty acids usually have 12 to 22 carbon atoms). Further, as a commercially available epoxy group-containing epoxide resin compound, EPON 815C is employable.

Further, acid scavengers employable other than the above ones include oxetane compounds, oxazoline compounds, organic acid salts of alkaline earth metal, acetylacetonate complexes, and those described in paragraphs 68 to 105 of Unexamined Japanese Patent Application Publication No. H05-194788.

Incidentally, an acid scavenger is also called an acid remover, an acid trapping agent, or an acid catcher but in the present invention, any of these can be used regardless of the names thereof.

### Fine Particles

The cellulose ester film according to the present invention preferably contains fine particles to provide slippage.

The primary average particle diameter of fine particles is preferably at most 20 nm, more preferably 5 to 16 nm, specifically preferably 5 to 12 nm.

These fine particles preferably form secondary particles of a particle diameter of 0.1 to 5 μm to be incorporated in a retardation film, and the average particle diameter thereof is preferably 0.1 to 2 μm, more preferably 0.2 to 0.6 μm, which makes it possible to form irregularities of a height of about 0.1 to 1.0 μm on the film surface and thereby appropriate slippage can be provided on the film surface.

In determination of the primary average particle diameter of fine particles, using a transmission electron microscope (with a magnification of 500,000 to 2,000,000), 100 particles were observed. One hundred particles were observed and then the particle diameters thereof were measured to obtain the average value as fire primary average particle diameter.

The apparent specific gravity of fine particles is preferably at least 70 g/l, more preferably 90 to 200 g/l, specifically preferably 100 to 200 g/l. With larger apparent specific gravity, a dispersion of larger concentration can be prepared, which is preferable since haze and aggregates are made favorable. Further, such fine particles are specifically preferably used to prepare a dope having large solid concentration as shown in the present invention.

The amount of fine particles added to cellulose acetate is preferably 0.01 parts by mass to 5.0 parts by mass, more preferably 0.05 parts by mass to 1.0 part by mass, most preferably 0.1 parts by mass to 0.5 parts by mass based on 100 parts by mass of the cellulose acetate. Relatively large added amount results in excellent dynamic friction coefficient and relatively small added amount generates less aggregates.

Further, a dope containing fine particles is preferably cast so as to be in direct contact with the casting support to obtain a film having enhanced slippage and reduced haze.

Still further, after peeling and drying preceded by casting to be wound as a roll, a functional thin film such as a hard coat layer or an antireflection layer may be provided. Packaging processing is commonly carried out to protect the product from dust adhesion due to dirt and static electricity until processing or shipment.

The package material therefor is not specifically limited as long as the above object is attained but those, which do not inhibit volatilization of the residual solvent from the film, are preferable. Specifically, polyethylene, polyester, polypropylene, nylon, polystyrene, paper, and unwoven fabrics are listed. Those in which fiber has a mesh cross shape are more preferably used.

### Method of Manufacturing Cellulose Acetate Film

The method of manufacturing the cellulose acetate film according to the present invention will now be described.

As the cellulose acetate film according to the present invention, either a film manufactured using a solution casting method or a film manufactured using a melt casting method is usable.

In the solution casting method, the cellulose acetate film according to the present invention is manufactured via a step to dissolve cellulose acetate and additives in a solvent to prepare a dope; a step to cast the dope on an endless metal support infinitely moving; a step to dry the thus-cast dope as a web; a step for peeling from the metal support; a step for stretching or width maintenance; a step for further drying; and a step to wind a finished film.

The step of preparing a dope is described below. The concentration of cellulose acetate in a dope is preferably large since the load of drying after casting on a metal support can be reduced. However, when the concentration of the cellulose acetate is excessively large, the load during filtration is increased, resulting in degraded filtering accuracy. The concentration to balance these is preferably 10 to 35% by mass, more preferably 15 to 25% by mass.

Solvents employed for a dope are used alone or in combination of at least two types. A good solvent and a poor solvent with respect to cellulose acetate are preferably used in combination in view of productivity. The good solvent preferably has larger amount in view of the solubility of the cellulose acetate.

With regard to a preferable range of the mixing ratio of a good solvent and a poor solvent, the good solvent falls within 70 to 98% by mass and the poor solvent falls within 2 to 30% by mass. With respect to the good solvent and the poor solvent, a solvent dissolving used cellulose acetate by itself is defined as a good solvent and a solvent causing swelling or no dissolution by itself is defined as a poor solvent.

The good solvent used in the present invention is not specifically limited, including organic halogen compounds such as methylene chloride, dioxolanes, acetone, methyl acetate, and methyl acetoacetate. Methylene chloride and methyl acetate are specifically preferably listed.

Further, the poor solvent used in the present invention is not specifically limited. For example, methanol, ethanol, n-butanol, cyclohexane, and cyclohexanone are preferably used. In the dope, water is preferably contained at 0.01 to 2% by mass.

As the solvent used to dissolve cellulose acetate, a solvent having been removed from the film by drying in the film forming step is recovered and then reused.

In the recovered solvent, additives added to cellulose acetate, for example, plasticizers, UV absorbents, polymers, and monomer components may be contained at minute amount. However, even with these contained therein, reuse can be preferably made, and reuse can be performed after purification if appropriate.

As the dissolving method of cellulose acetate for preparing the above dope, an appropriate common method is employable. The combination of heating and pressurization can realize heating up to at least boiling point under normal pressure.

When stirring and dissolution with heating are preferably carried out in a temperature range in which the range is at least the boiling point of a solvent under normal pressure and also the solvent will not boil under pressure to prevent generation of aggregated undissolved substance called gel or powdery mass.

Further, a method in which cellulose acetate is mixed with a poor solvent to be wetted and swollen, followed by addition of a good solvent for dissolution is preferably used.

Pressurization may be carried out by a method to inject inert gas such as nitrogen gas or a method to raise the vapor pressure of a solvent by heating. Heating is preferably carried out from the outside and for example, a jacket-type is preferable because of easy temperature controlling.

The heating temperature after adding a solvent is preferably high from the viewpoint of the solubility of cellulose acetate but when the heating temperature is excessively high, required pressure increases, resulting in poor productivity.

The heating temperature is preferably 45 to 120° C., more preferably 60 to 110° C., still more preferably 70 to 105° C. Further, the pressure is adjusted so as for the solvent not to boil at a set temperature.

Alternatively, a cooling dissolution method is also preferably used, which makes it possible to dissolve cellulose acetate in a solvent such as methyl acetate.

Subsequently, this cellulose acetate solution is filtered using an appropriate filter material such as filter paper. The filter material preferably has small absolute filtering accuracy to eliminate insoluble substance but with excessively small absolute filtering accuracy, the problem that the filter material tends to clog is produced.

Therefor, a filter material having an absolute filtering accuracy of at most 0.008 mm is preferable, more preferably 0.001 to 0.008 mm, still more preferably 0.003 to 0.006 mm.

The material of the filter material is not specifically limited and a common filter material can be used. However, a plastic filter material such as polypropylene or TEFLON (a trademark) and a metal filter material such as stainless steel are preferable in view of no dropping of fiber.

Via filtration, impurities, especially, luminescent spot foreign matters contained in cellulose acetate as the raw material are preferably eliminated or reduced.

When 2 polarizing plates are arranged in the cross-nicol state and a cellulose acetate film is placed therebetween; and then light is irradiated form one polarizing plate side and observation is made from the other polarizing plate side, the luminescent spot foreign matters refer to spots (foreign matters) viewed due to the leakage of light from the opposite side. The number of luminescent spots having a diameter of at least 0.01 mm is preferably at most 200/cm².

The number is more preferably at most 100/cm², still more preferably at most 50/cm², yet still more preferably at most 0 to 10/cm². Further, the number of luminescent spots of at most 0.01 mm is preferably small.

A dope can be filtered using a common method. However, preferable is a method in which filtration is carried out while heating at the boiling point or more of a solvent under normal pressure, as well as at a temperature where the solvent will not boil under pressure, since the increase of the difference of filtration pressure (referred to as differential pressure) prior to and after filtration is minimized.

The preferable temperature is 45 to 120° C., more preferably 45 to 70° C., still more preferably 45 to 55° C.

The filtration pressure is preferably small. The filtration pressure is preferably at most 1.6 MPa, more preferably at most 1.2 MPa, still more preferably at most 1.0 MPa.

Next, casting of a dope will be described.

As the metal support in the casting step, those whose surface is mirror-finished are preferable. As the metal support, a stainless steel belt or a drum which is a cast metal whose surface is plated is preferably used.

The cast width can be allowed to be 1 to 4 mm. The surface temperature of the metal support in the casting step is −50° C. to less than the boiling point of the solvent and the temperature is preferably high since the drying rate of a web can be increased. However, excessively high temperatures may cause foaming in the web and flatness degradation.

The support temperature is preferably 0 to 55° C., more preferably 25 to 50° C. Alternatively, preferable is a method in which a web is gelated via cooling and then in the state where a large amount of the residual solvent is contained, the web is peeled from the drum.

The method of controlling the temperature of the metal support is not specifically limited, including a method of blowing warm air or cool air and a method of bringing warm water into contact with the rear side of the metal support. Use of warm water is preferable since efficient heat transfer thereby reduces the time until the temperature of the metal support becomes constant. In the case of use of warm air, wind having a temperature higher than the targeted temperature is occasionally employed.

To allow a cellulose acetate film to exhibit excellent flatness, the residual solvent amount during peeling of a web from the metal support is preferably 10 to 150% by mass, more preferably 20 to 40% by mass or 60 to 130% by mass, specifically preferably 20 to 30% by mass or 70 to 120% by mass.

In the present invention, the residual solvent amount is defined by the following expression:

Residual solvent amount (% by mass)={(M−N)/N}×100

wherein M represents the mass of a sample obtained at an arbitrary point during or after manufacturing of a web or film and N represents the mass after 1-hour heating of M at 115° C.

Further, in the drying step of a cellulose acetate film, a web is peeled from the metal support, followed by drying and thereby the residual solvent amount is allowed to be preferably at most 1% by mass, more preferably at most 0.1% by mass, specifically preferably 0 to 0.01% by mass.

In the film drying step, there is commonly employed a roll drying method (a web is alternately passed through a number of rolls arranged alternately up and down to be dried) or a drying method in which using a tenter system, a web is conveyed.

To manufacture the cellulose acetate film according to the present invention, using a tenter system to hold both edges of a web with clips, stretching is specifically preferably carried out in the width direction (the transverse direction). Peeling is preferably carried out at a peeling tension of at most 300 N/m.

The method of drying a web is not specifically limited and hot air, infrared radiation, a heating roll, microwaves are generally employable. Hot air is preferably employed from the viewpoint of convenience.

The drying temperature in the web drying step is preferably raised in a step-like manner at 40 to 200° C.

The film thickness of a cellulose acetate film is not specifically limited but a film thickness of 10 to 200 μm is employed. Especially, the film thickness is preferably 10 to 100 μm, more preferably 20 to 60 μm.

In the present invention, a cellulose acetate film of a width of 1 to 4 m is used. Especially, a film of a width of 1.4 to 4 m is preferably used, specifically preferably 1.6 to 3 m. A film of a width of more than 4 m is difficult to convey.

To provide the following desired retardation values Ro and Rt for a cellulose acetate film, it is preferable to control conveyance tension and refractive index via a stretching operation.

For example, when the tension of the longitudinal direction is decreased or increased, retardation value can be allowed to vary.

Further, sequential or simultaneous biaxial stretching or uniaxial stretching is preferably carried out in the longitudinal direction (the film forming direction) of the film and in the direction at right angles thereto in-plane of the film, i.e., in the transverse direction.

The stretching factors of biaxial directions at right angles to each other are finally preferably 0.8 to 1.5 in the casting direction and 1.1 to 2.5 in the width direction, more preferably 0.8 to 1.0 in the casting direction and 1.2 to 2.0 in the width direction, respectively.

Stretching is preferably carried out at a stretching temperature of 120 to 200° C., more preferably 150 to 200° C., still more preferably more than 150 to 190° C.

In stretching, the residual solvent amount in the film is preferably 0 to 20%, more preferably 0 to 15%.

Specifically, stretching is preferably carried out at a residual solvent amount of 11% at 155° C. or at a residual solvent amount of 2% at 155° C. Alternatively, stretching is preferably carried out at a residual solvent amount of 11% at 160° C. or at a residual solvent amount of less than 1% at 160° C.

The web stretching method is not specifically limited, including, for example, a method in which a plurality of rolls are allowed to differ in peripheral velocity and among these, using the roll peripheral velocity difference, stretching is carried out in the longitudinal direction; a method in which both edges of a web is fixed using clips or pins and then the distance between the clips or pins is widened in the moving direction for stretching in the longitudinal direction; a method in which stretching is carried out in the transverse direction with widening in the transverse direction in the same manner as described immediately above; and a method in which stretching is carried out in the longitudinal and transverse directions with simultaneous widening longitudinally and transversely. Of course, these methods may be combined.

Further, in a so-called tenter method, it is preferable to use a linear drive system to drive clipped portions, and thereby smooth stretching can be carried out, resulting in a decrease in the possibility of breakage.

The width maintenance and stretching in the transverse direction in the film forming step are preferably carried out using a tenter, which may be a pin tenter or a clip tenter.

When the delayed phase axis or the advanced phase axis of the cellulose acetate film according to the present invention is present in-plane of the film and then the angle to the film forming direction is designated as θ1, θ1 is preferably −1° to +1°, more preferably −0.5° to +0.5°, still more preferably −0.1° to +0.1°.

This θ1 can be defined as orientation angle and θ1 can be determined using automatic birefringence meter KOBRA-21ADH (produced by Oji Scientific Instruments Ltd.). Satisfying the above relationship by θ1 can contribute to obtaining enhanced brightness in a displayed image and to inhibiting or preventing light leakage; and to obtaining faithful color reproduction in a color liquid crystal, display device.

### Physical Properties of Cellulose Acetate Film

The moisture permeability of the cellulose acetate film according to the present invention is preferably 300 to 1,800 g/m²·24 h at 40° C. and 90% RH, more preferably 400 to 1,500 g/m²·24 h, specifically preferably 40 to 1,300 g/m²·24 h. Moisture permeability can be determined based on the method described in JIS Z 0208.

The fracture elongation is preferably 5 to 80%, more preferably 10 to 50%.

The visible light transmittance is preferably at least 90%, more preferably at least 93%.

Further, when a liquid crystal layer is coated on the cellulose acetate film according to the present invention, a retardation value covering a wider range can be obtained.

### Retardation Value

With regard to the in-plane retardation value (Ro) and the retardation value (Rt) in the thickness direction of the cellulose acetate film according to the present invention, 0≦Ro and Rt≦70 nm are preferable; 0≦Ro≦30 nm and 0≦Rt≦50 nm are more preferable; and 0≦Ro≦10 nm and 0≦Rt≦30 nm are still more preferable in the case of use as a polarizing plate protective film.

The cellulose acetate film according to the present invention is preferably used as a retardation film, preferably having 30≦Ro≦100 nm and 70≦Rt≦400 nm, more preferably 35≦Ro≦65 nm and 90≦Rt≦180 nm in this case. Further, Rt variation and distribution widths are preferably less than ±50%, more preferably less than ±30%, and still more preferably less than ±20%. The widths are further more preferably less than ±15%, yet preferably less than ±10%, yet more preferably less than ±5%, and specifically preferably less than ±1%. However, no Rt variation is most preferable.

Incidentally, retardation values Ro and Rt can be determined based on the following expressions:

Ro=(nₓ−n_{y})×d

Rt=((nₓ+n_{y})/2−n_{z})×d

wherein d represents the film thickness (nₘ); and as refractive indexes, there are designated nₓ (the maximum refractive index in-plane of the film, being also referred to as the refractive index of the delayed phase axis direction), n_{y} (the refractive index of the direction at right angles to the delayed phase axis in-plane of the film), and n_{z} (the refractive index of the film in the thickness direction).

Such retardation values (Ro) and (Rt) can be determined using an automatic birefringence meter. These values can be determined, for example, using KOBRA-21ADH (produced by Oji Scientific Instruments Ltd.) at a wavelength of 590 nm under an ambience of 23° C. and 55% RH.

### Functional Layer

In the case where the cellulose acetate film according to the present invention is used as a polarizing plate protective film used on the surface side of a liquid crystal display device, a functional layer such as an antireflection layer, an antistatic layer, an anti-stain layer, and a back coat layer, other than an anti-glare layer and a clear hard coat layer, is preferably provided on the protective film surface.

### Manufacturing of Polarizing Plate

The polarizing plate of the present invention is a polarizing plate in which the protective film according to the present invention is laminated to at least one face of a polarizer. The liquid crystal display device according to the present invention is constructed of a liquid crystal cell and 2 polarizing plates arranged on both sides thereof, and at least one of the polarizing plates is the polarizing plate according to the present invention, being laminated via an adhesive layer.

The method of manufacturing the polarizing plate of the present invention will now be described.

The side to be laminated to the polarizer of the protective film according to the present invention, having been immersed in an alkali saponification liquid and hydrophilized, is preferably laminated to at least one face of a polarizer, having been prepared via immersion stretching in an iodine solution, using a completely saponified polyvinyl alcohol aqueous solution.

### Saponification Treatment Method

The alkali saponification treatment method according to the present invention will now be described that by no means limits the scope of the present invention.

A protective film is commonly stored in a roll form as a master roll of a long-length film, and the protective film having been unwound from the master roll is immersed and conveyed in a bath in which a saponification liquid is stored for saponification treatment. At this time, a protect film such as a polyester film is also laminated to the surface not to be saponified for protection. After saponification treatment, the surface of the protective film is rinsed with water and a neutralizer and then squeezed to be introduced into a heating apparatus for drying. In drying, a plurality of guide rolls hold the film to be conveyed. After the heating step, winding is carried out if appropriate.

As the saponification liquid, an aqueous solution of NaOH or KOH is commonly used. Its concentration is preferably 0.5 mol/l to less than 1.5 mol/l in view of safety, the environment, and cost.

The temperature of the saponification liquid is preferably 20° C. to 55° C., more preferably 25° C. to 50° C. in order to uniformly carry out saponification treatment for a relatively short period of time. The duration when saponification treatment is carried out in the bath is not specifically limited, being, however, preferably 5 seconds to 5 minutes, more preferably 10 seconds to 2 minutes. The saponification liquid is preferably stirred for uniform saponification treatment.

Conditions such as concentration, temperature, and duration concerning the saponification liquid the preferably adjusted so as to satisfy following Formula (W).

The mass change rate of the mass (b) after saponification treatment and washing to the mass (a) prior to saponification treatment of the protective film preferably satisfies following Formula (W).

((b−a)/a)×100≧0(%) Formula (W):

a: Film mass after 24-hour humidity conditioning, under a condition of 23° C. and 55%, of a protective film prior to alkali treatment

b: Film mass after 24-hour humidity conditioning, under a condition of 23° C. and 55%, of the protective film after alkali treatment and washing

Commonly, when a cellulose ester is subjected to saponification treatment, its mass does not change compared prior to saponification treatment or an increase of 0 to about 0.5% in the mass is observed. It is thought that the reason is that part or the most part of surface hydroxyl groups having been generated by deacylation formed salts, together with alkali metal in the saponification liquid.

However, excessive saponification (more than 3.0 in Formula (S II)) results in mass decrease. The reason is thought to be that the saponification liquid allows hydrolysis of the main chain of cellulose acetate to advance and then the resin itself is eluted. In the present invention, saponification treatment is preferably carried out under a condition where the resin itself is not eluted, namely, under the condition satisfying Formula (W).

The temperature of heating for the above drying is not specifically limited, as long as the saponification liquid is evaporated at the temperature, being, however, preferably 50° C. to 120° C., more preferably 60° C. to 100° C. Hot air is preferably blown onto the surface during heating to reduce the drying duration.

For the other face of the polarizing plate, a protective film according to the present invention may be used or another polarizing plate protective film may be laminated thereto

Also preferably usable are, for example, commercially available cellulose ester films (for example, Konica Minolta TAC KC8UX, KC5UX, KC8UCR3, KC8UCR4, KC8UCR5, KC8UY, KC4UY, KC4UE, KC8UE, KC8UY-HA, KC8UX-RHA, KC8UXW-RHA-C, KC8UXW-RHA-NC and KC4UXW-RHA-NC, all produced by Konica Minolta Opto, Inc.).

A polarizer being a main constituent element of a polarizing plate refers to an element permitting only light of a polarized wave plane of a predetermined direction to pass. A typical polarizer currently known is a polyvinyl alcohol-based polarizing film, which includes those prepared by dyeing a polyvinyl alcohol-based film with iodine and those dyed with a dichroic dye.

As the polarizer, those prepared as follows are used: a polyvinyl alcohol aqueous solution is subjected to film formation, and then the resulting film is uniaxially stretched and then dyed, or is dyed and then uniaxially stretched; and thereafter, durability treatment is preferably carried out using a boron compound. The film thickness of the polarizer is preferably 5 to 30 μm, specifically preferably 10 to 20 μm.

Further, ethylene-modified polyvinyl alcohols, as described in Unexamined Japanese Patent Application Publication Nos. 2003-248123 and 2003-342322, having an ethylene unit content of 1 to 4 mol %, a polymerization degree of 2,000 to 4,000, and a saponification degree of 99.0 to 99.99 mol %, are also preferably used.

Of these, an ethylene-modified polyvinyl alcohol having a hot water breaking temperature of 66-73° C. is preferably used.

A polarizer employing this ethylene-modified polyvinyl alcohol exhibits excellent polarizing performance and durability performance, as well as exhibiting minimal color spotting, being specifically preferably used for a large size liquid crystal display device.

An adhesive to laminate a polarizer and a cellulose acetate film includes a PVA-based adhesive and a urethane-based adhesive. Of these, a PVA based adhesive is preferably used.

### Liquid Crystal Display Device

When the polarizing plate of the present invention is used for a liquid crystal display device, various types of liquid crystal display device exhibiting excellent visibility can be produced.

The polarizing plate of the present invention can be used for liquid crystal display devices of various drive types such as STN, TN, OCB, HAN, VA (MVA, PVA), IPS and OCB.

Of these, a VA (MVA, PVA)-type liquid crystal display device is preferable.

Especially, even in the case of a large screen liquid crystal display device having a screen of at least 30-type, a liquid crystal display device, exhibiting informal environmental variation, reduced light leakage, and excellent visibility with respect to color tone non-uniformity and front contrast, can be obtained.

### Examples

The present invention will now specifically be described with reference to examples that by no means limit the scope of the present invention.

### Example 1

### Production of Protective Film 1

### Fine Particle Dispersion

| | |
|---|---|
| Fine particles (AEROSIL R812, produced by | 11 parts by mass |
| Nibon Aerosil Co., Ltd.) | |
| Ethanol | 89 parts by mass |

The above materials were stirred and mixed for 50 minutes using a dissolver, followed by dispersion using a Manton-Gaulin homogenizer.

### Fine Particle Adding Liquid

Into a dissolving tank charged with methylene chloride, cellulose acetate CE-1 described in Table 1 was added, followed by being heated for complete dissolution. The resulting product was filtered using AZUMI FILTER PAPER No. 244 (produced by Azumi Filter Paper Co., Ltd.). As the cellulose acetate solution after filtration was sufficiently stirred, the fine particle dispersion was slowly added thereinto. Further, dispersion was carried out using an atliter so as to allow the particle diameter of secondary particles to have a predetermined value. The resulting dispersion was filtered using FINEMET NF (produced by Nippon Seisen Co., Ltd.) to prepare a fine particle adding liquid.

| | |
|---|---|
| Methylene chloride | 99 parts by mass |
| CE-1 | 4 parts by mass |
| Fine particle dispersion | 11 parts by mass |

Subsequently, using cellulose acetates CE-5 and CE-2 described in Table 1, a main dope liquid having a composition described later was prepared.

Initially, methylene chloride and ethanol were placed into a pressurized dissolution tank. The pressurized dissolution tank containing the solvents was charged with CE-5 and CE-2 with stirring. This reaction system was heated and completely dissolved with stirring, followed by adding two types of additive described in Table 3 to be dissolved. The resulting product was filtered using AZUMI FILTER PAPER No. 244 (produced by Azumi Filter Paper Co., Ltd.) to prepare a main dope liquid.

Two parts by mass of the fine particle adding liquid was added to 100 parts by mass of the main dope liquid, followed by sufficient mixing using an in-line mixer (Toray static in-line mixer, Hi-Mixer, SWJ) to be uniformly cast on a stainless steel band support of a width of 2 m using a belt casting apparatus. The solvents were evaporated on the stainless steel band support until the residual solvent amount reached 110% for peeling from the stainless steel band support. During peeling, a tension was applied for stretching so that the longitudinal (MD) stretching factor became 1.02. Then, both web edges were held by a tenter set at 160° C. and stretching was carried out so that the stretching factor of the transverse (TD) direction became 1.35. The amount of the residual solvent at stretching initiation was 10%. After stretching, with the width maintained, holding was continued for several seconds. Thereafter, the tension of the width direction was relaxed and then width holding was released. Further, in a drying zone set at 125° C., conveyance was carried out for 30 minutes for drying to produce protective film 1 of the present invention of a film thickness of 40 μm having a width of 1.5 m, as well as a knurling pattern of a width of 1 cm and a height of 8 μm on each edge.

### Composition of the Main Dope Liquid

| | | |
|---|---|---|
| Methylene chloride | 300 | parts by mass |
| Ethanol | 30 | parts by mass |
| CE-5 | 60 | parts by mass |
| CE-2 | 40 | parts by mass |
| Additive A (compound A-5) | 6.5 | parts by mass |
| Additive B (compound B-16) | 6 | parts by mass |

### Production of Protective Films 2 to 10

Protective films 2 to 10 were produced in the same manner as above except that the cellulose acetates and the additives were changed as described in Table 2 and Table 3.

The degree of acyl group substitution and the weight average molecular weight of each of cellulose acetates CE-1 to CE-9 are shown below.

TABLE 2

| | | Degree of Acyl Group Substitution | | |
|---|---|---|---|---|
| Cellulose | Weight Average | | | Total |
| Acetate | Molecular Weight | Acetyl | Propionyl | Substitution |
| No. | Mw | Group | Group | Degree |
| CE-1 | 181,000 | 2.41 | 0 | 2.41 |
| CE-2 | 194,000 | 2.43 | 0 | 2.43 |
| CE-3 | 116,000 | 2.48 | 0 | 2.48 |
| CE-4 | 155,000 | 2.28 | 0 | 2.28 |
| CE-5 | 143,000 | 2.37 | 0 | 2.37 |
| CE-6 | 124,000 | 2.15 | 0 | 2.15 |
| CE-7 | 265,000 | 2.88 | 0 | 2.88 |
| CE-8 | 149,000 | 1.92 | 0.74 | 2.66 |
| CE-9 | 185,000 | 1.56 | 0.9 | 2.46 |

Herein, weight average molecular weights Mw in the table was determined based on the above method.

TABLE 3

| | Cellulose Acetate 1 | | Cellulose Acetate 2 | | | | | | | | | | |
|---|---|---|---|---|---|---|---|---|---|---|---|---|---|
| | | Cellulose | | Cellulose | Additive A | | | Additive B | | | Surface Energy prior | | |
| Protective | | Acetate | | Acetate | | Parts by | | | Parts by | | to Hydrophilization | | |
| Film No. | CE. No. | Ratio % | CE. No | Ratio % | Compound | Mass | logP | Compound | Mass | logP | γsh | γsp | γsh/γsp |
| 1 | CE-5 | 60 | CE-2 | 40 | A-5 | 6.5 | 10.8 | B-16 | 4 | 5.5 | 9.2 | 28.0 | 0.33 |
| 2 | CE-5 | 100 | — | — | TPP | 8 | 5.6 | BDP | 6 | 7.3 | 8.1 | 29.6 | 0.27 |
| 3 | CE-1 | 100 | — | — | A-4 | 11 | 11.8 | B-16 | 5 | 5.5 | 8.5 | 30.5 | 0.28 |
| 4 | CE-3 | 80 | CE-1 | 20 | PETB | 9 | 9.9 | B-18 | 3 | 1.2 | 8.6 | 29.2 | 0.29 |
| 5 | CE-4 | 50 | CE-6 | 50 | A-4 | 7 | 11.8 | B-15 | 2 | 5.5 | 9.3 | 27.6 | 0.34 |
| 6 | CE-5 | 90 | CE-1 | 10 | A-5 | 5 | 10.8 | B-15 | 2 | 5.5 | 9.7 | 26.8 | 0.36 |
| 7 | CE-7 | 100 | — | — | Compound 16 | 5 | 7.9 | EPEG | 5 | 2.3 | 5.5 | 34.8 | 0.16 |
| 8 | CE-8 | 100 | — | — | TPP | 5 | 5.6 | EPEG | 5 | 2.3 | 6.3 | 33.5 | 0.19 |
| 9 | CE-9 | 100 | — | — | A-5 | 8 | 10.8 | B-15 | 2 | 5.5 | 6.9 | 32.2 | 0.21 |
| 10 | CE-3 | 100 | — | — | A-5 | 15 | 10.8 | SMA1000P | 5 | 2.1 | 7.2 | 30.9 | 0.23 |

Herein, the compounds having the following abbreviations in the table are as follows:
TPP: Triphenyl phosphate
BDP: Biphenyldiphenyl phosphate
PETB: pentaerythritol-tetrabenzoate
EPEG: Ethylphthalyl ethylglycolate
SMA 1000P: Styrene-maleic anhydride (1:1) copolymer (produced by Sartomer USA, LLC)

### Production of Polarizing Plates

Obtained protective films 1 to 10 were immersed and then hydrophilized in a bath in which an alkali saponification liquid was stored under conditions described in Table 4 to produce polarizing plates based on the following.

TABLE 4

| Alkali | | | |
|---|---|---|---|
| Saponification | | Concentration | Temperature |
| Condition | Alkali Type | (mol/l) | (° C.) |
| 1 | NaOH | 0.4 | 35 |
| 2 | NaOH | 0.5 | 40 |
| 3 | NaOH | 2.1 | 45 |
| 4 | NaOH | 1.9 | 20 |
| 5 | NaOH | 1.5 | 55 |
| 6 | KOH | 1.4 | 50 |
| 7 | NaOH | 1.5 | 30 |

A polyvinyl alcohol film of a thickness of 120 μm was uniaxially stretched (temperature: 110° C. and stretching factor: 5). The resulting film was immersed in an aqueous solution containing 0.075 g of iodine, 5 g of potassium iodide, and 100 g of water for 60 seconds and thereafter in an aqueous solution containing 6 g of potassium iodide, 7.5 g of boric acid, and 100 g of water at 68° C. The thus-immersed film was washed and dried to obtain a polarizer.

Then, based on the following steps 1 to 5, the polarizer and protective films 1 to 10 each, as well as Konica Minolta TAC KC8UY (produced by Konica Minolta Opto, Inc.) for the rear face side serving as a polarizing plate protective film, were laminated together to produce polarizing plates.

Step 1: Protective films 1 to 10 were hydrophilized under conditions in Table 4.

Step 2: The polarizer was immersed in a bath containing a polyvinyl alcohol adhesive of a solid content of 2% by mass for 1 to 2 seconds.

Step 3: An excessive amount of the adhesive having adhered to the polarizer in step 2 was lightly wiped off and the thus-treated polarizer was placed on the protective film, having been hydrophilized in step 1, and further the rear face side cellulose ester film was layered to be arranged.

Step 4: Protective films 1 to 10 each, the polarizer, and the rear face side cellulose ester film having been layered in step 3 were laminated together at a pressure of 20 to 30 N/cm² and a conveyance rate of about 2 m/minute.

Step 5: Samples having been produced in step 4 via laminating of the polarizer, protective films 1 to 10 each, and the rear face side cellulose ester film were dried in a dryer of 80° C. for 2 minutes to produce polarizing plates.

### Evaluation Items and Evaluation Methods

Using the obtained protective films, the following evaluations were conducted.

### Surface Free Energy

The surface free energy of a protective film was determined as follows.

In determination, a protective film prior to alkali saponification treatment was subjected to humidity conditioning under a condition of 23° C. and 55% for 24 hours. A protective film after alkali saponification treatment was subjected to alkali treatment and washing, followed by humidity conditioning under a condition of 23° C. and 55% for 24 hours for determination.

The contact angle between each of 3 types of reference liquid of pure water, nitromethane, and methylene iodide and a determined solid was measured 5 times using contact angle meter CA-V (produced by Kyowa Interface Science Co., Ltd.) to obtain an average contact angle from the average of measured values. Then, on the basis of Young-Dupre Equation and extended Fowkes Equation, 3 components of the surface free energy of the solid were calculated.

W_{SL}=γL(1+cos θ) Young-Dupre Equation:

W_{SL}: Adhesion energy between liquid and solid

γL: Surface free energy of the liquid

θ: Contact angle between the liquid and the solid

W_{SL}=2{(γsdγLd)^{1/2}+(γspγLp)^{1/2}+(γshγLh)^{1/2}} Extended Fowkes Equation:

γL=γLd+γLp+γLh: Surface free energy of liquid

γs=γsd+γsp+γsh: Surface free energy of solid

γd, γp, and γh: Each component of dispersion, dipole, and hydrogen bond of surface free energy

Each component value (mN/m) of the surface free energy of a reference liquid is known as shown in above Table 1. Therefore, when the simultaneous equation with three unknowns is solved using a contact angel value, each of the component values (γsd, γsp, and γsh) of the surface free energy of the solid surface can be determined.

### Mass Change after Saponification

In mass determination, a protective film prior to alkali saponification treatment was subjected to humidity conditioning under a condition of 23° C. and 55% for 24 hours. A protective film after alkali saponification treatment was subjected to alkali treatment and washing, followed by humidity conditioning under a condition of 23° C. and 55% for 24 hours for determination.

The change rate of the mass (b) after saponification treatment and washing to the mass (a) prior to saponification treatment was determined by following Formula (W).

((b−a)/a)×100≧0(%) Formula (W):

a: Film mass of a protective film prior to alkali treatment

b: Film mass of a protective film having been subjected to alkali treatment and washing

A:((b−a)/a)×100≧0(%)

B: ((b−a)/a)×100<0(%)

### White Foreign Substances of the Saponification Liquid

Under conditions of Table 5, 24-hour continuous alkali saponification treatment was carried out and thereafter the saponification liquid was sampled to be visually confirmed. When white foreign substances had been confirmed, the film after saponification was also visually confirmed.

A: No white foreign substance can be confirmed in the saponification liquid

B: White foreign substances can be slightly confirmed in the saponification liquid but no re-adhesion to the film can be confirmed.

C: Many white foreign substances can be confirmed in the saponification liquid and also re-adhesion to the film occurs.

### PVA Adhesion Performance

The adhesion face of an obtained polarizing plate was peeled off by hand under a condition of 23° C. and 55% RH and then the extent of material breakage and peelability was visually observed to evaluate adhesion performance based on the following criteria.

A: Material (substrate) breakage occurs.

B: Material (substrate) breakage partially occurs but an area peeled at the interface between the polarizing plate protective film and the polarizer exists.

C: Peeling at the interface between the polarizing plate protective film and the polarizer occurs

The evaluation results are shown in Table 5.

TABLE 5

| | | | | | | | White Foreign | | |
|---|---|---|---|---|---|---|---|---|---|
| | | | Surface Energy after | | | Mass Change prior | Substance in | | |
| Protective | Saponification | Treatment | Hydrophilization | | | to and after | Saponificafion | PVA Adhesion | |
| Film No. | Condition | Duration (sec) | γsh | γsp | γsh/γsp | Saponification | Liquid | Performance | Remarks |
| 1 | 1 | 90 | 20.1 | 13.6 | 1.48 | A | A | C | comparative |
| 1 | 2 | 15 | 23.1 | 14.8 | 1.56 | A | A | B | inventive |
| 1 | 2 | 45 | 24.3 | 12.1 | 2.01 | A | A | A | inventive |
| 1 | 3 | 15 | 24.5 | 11.5 | 2.13 | A | A | A | inventive |
| 1 | 3 | 90 | 26.0 | 9.3 | 2.81 | A | B | A | inventive |
| 1 | 4 | 15 | 17.9 | 13.3 | 1.35 | A | A | C | comparative |
| 1 | 4 | 60 | 23.0 | 11.8 | 1.95 | A | A | A | inventive |
| 1 | 5 | 90 | 29.6 | 8.8 | 3.35 | C | C | A | comparative |
| 1 | 6 | 90 | 26.0 | 9.7 | 2.67 | A | A | A | inventive |
| 2 | 3 | 90 | 28.8 | 10.4 | 2.78 | A | B | A | comparative |
| 2 | 3 | 30 | 26.0 | 8.9 | 2.92 | A | B | A | inventive |
| 3 | 2 | 30 | 22.2 | 13.8 | 1.61 | A | A | B | inventive |
| 4 | 2 | 90 | 22.1 | 10.5 | 2.10 | A | A | A | inventive |
| 4 | 5 | 30 | 26.1 | 8.6 | 3.05 | C | C | A | comparative |
| 5 | 2 | 30 | 20.0 | 10.1 | 1.99 | A | A | A | inventive |
| 6 | 2 | 30 | 21.7 | 10.5 | 2.06 | A | A | A | inventive |
| 6 | 1 | 120 | 20.8 | 12.8 | 1.62 | A | A | B | inventive |
| 7 | 2 | 30 | 15.7 | 18.7 | 0.84 | A | A | C | comparative |
| 8 | 2 | 30 | 16.9 | 17.4 | 0.97 | A | A | C | comparative |
| 9 | 2 | 30 | 14.2 | 21.2 | 0.67 | A | A | C | comparative |
| 10 | 2 | 30 | 17.3 | 16.6 | 1.04 | A | A | C | comparative |
| 10 | 7 | 30 | 17.6 | 12.8 | 1.37 | A | A | C | comparative |

In a protective film having the surface free energy prior to alkali saponification treatment and after alkali saponification treatment specified in the present invention and a polarizing plate using the same, as is obvious from any sample of the present invention of Table 5, there existed no white foreign substance in the saponification liquid and also excellent adhesion performance to the polarizer (PVA) was expressed. The results confirmed that a protective film and a polarizing plate manufactured by the method of manufacturing a polarizing plate of the present invention exhibited excellent adhesion performance to the polarizer and also were able to be manufactured under saponification treatment conditions featuring working safety and minimal environmental load.

### Example 2

### Production of Liquid Crystal Display Devices

A liquid crystal panel to be visually evaluated was produced as described below, and characteristics as a liquid crystal display device were evaluated.

The polarizing plates of both faces which had been previously laminated to 40-type display KLV-40V 2500 (produced by Sony Corp.) were removed and an above-produced polarizing plate was laminated to each side of the glass face of the liquid crystal cell.

In this case, with respect to the direction of laminating of the polarizing plate, the face of the protective film of the present invention was allowed to be on the liquid crystal cell side and the absorption axis was allowed to be in the same direction as that of the polarizing plate having been previously laminated to produce each liquid crystal display device.

The visibility of this liquid crystal display device was evaluated with the naked eye. Any liquid crystal display device mounted with a polarizing plate produced by the method of manufacturing a polarizing plate of the present invention exhibited enhanced clarity and contrast, resulting in excellent visibility.

1. A method of manufacturing a polarizing plate in which a protective film having been hydrophilized by alkali saponification is laminated to at least one face of a polarizer; in which
the protective film contains cellulose acetate; and
a surface free energy of the protective film prior to alkali saponification satisfies following Formula (S I), and a surface free energy of the protective film after alkali saponification satisfies following Formula (S II),
0.25≦γsh/γsp≦0.40 (S I):
1.5≦γsh/γsp≦3.0 (S II):
wherein γsh represents a hydrogen bond component of the surface free energy of the protective film and γsp represents a dipolar component of the surface free energy of the protective film.

2. The method of manufacturing the polarizing plate of claim 1, in which the cellulose acetate is diacetyl cellulose having a degree of acetyl group substitution of 2.0 to less than 2.5.

3. The method of manufacturing the polarizing plate of claim 2, in which the cellulose acetate is diacetyl cellulose having a weight average molecular weight of 100,000 to less than 200,000.

4. The method of manufacturing the polarizing plate of claim 1, in which the protective film contains a hydrolysis inhibitor having a log P value of at least 10.0 at 6.0% by mass or more based on a resin content.

5. The method of manufacturing the polarizing plate of claim 1, in which a mass change rate of mass (b) after saponification and washing to mass (a) prior to saponification of the protective film satisfies following Formula (W),
((b−a)/a)×100≧0(%) (W):
wherein
a represents a mass of the protective film prior to alkali treatment after 24-hour humidity conditioning under a condition of 23° C. and 55%, and
b represents a mass of the protective film after alkali treatment and washing after 24-hour humidity conditioning under a condition of 23° C. and 55%.

6. The method of manufacturing the polarizing plate of claim 1, in which a temperature of the alkali saponification is 25 to 50° C.

7. The method of manufacturing the polarizing plate of claim 1, in which an alkali (NaOH or KOH) concentration (mol/l) of the alkali saponification is 0.5 to less than 1.5.

8. A polarizing plate manufactured by the method of manufacturing a polarizing plate of claim 1.

9. A liquid crystal display device composed of a liquid crystal cell and two polarizing plates arranged on both sides thereof, in which at least one of the polarizing plates is the polarizing plate of claim 8.
